(19) United States
(12) Patent Application Publication
(10) Pub. No.: US 2012/0064238 A1
(43) Pub. Date: Mar. 15, 2012

(54) Methods of Making Powder Coating Compositions, Powder Coating Compositions Made Thereby, and Powder Coating Systems

(76) Inventors: Shawn DeSaw, McMurray, PA (US); Dennis Faler, North Huntingdon, PA (US); Kurt Humbert, Pittsburgh, PA (US); Kevin Woolerton, McCandless Township, PA (US)

(21) Appl. No.: 12/882,534

(22) Filed: Sep. 15, 2010

(51) Int. Cl. B05D 5/06; C09D 5/00

(52) U.S. Cl. 427/201; 523/206

(57) ABSTRACT

Methods for making powder coating compositions are disclosed in which at least one first powder coating composition and at least one second powder coating composition are mixed. The at least one first powder coating composition, when deposited upon a substrate and cured, provides a cured coating having a first hue and a first L* value, and includes opaque particulates. The at least one second powder coating composition includes translucent or opaque particulates that have external colorant particles removably adhered thereto. In the methods, the mixture, when deposited upon a substrate and cured, produces a coating having an L* value within 20 units of the L* value of a coating formed from the at least one first powder coating composition alone. Also disclosed are powder coating compositions produced by the disclosed methods, powder coating systems, related kits, methods for matching a preselected hue, coated substrates, and method for coating a substrate.

### FIELD OF THE INVENTION

The present invention relates to methods for making powder coating compositions, powder coating compositions made by such methods, and powder coating systems comprising a plurality of powder coating compositions. The present invention also relates to, among other things, methods for using such powder coating compositions to form opaque coatings having a selected homogeneous hue.

### BACKGROUND INFORMATION

Powder coatings compositions are often desired, since they can greatly reduce, or even eliminate, use of the organic solvents often present in liquid coating compositions. Powder coatings are typically produced by a process that includes dry blending various coating components, such as color pigments, film-forming resins, curing agents, and other additives, such as flow control agents and charge control agents, subjecting the resulting blend to heating, melting and kneading by use of an extruder, and then subjecting the resulting extrudate to cooling, grinding and classification (referred to herein as the “Extrusion Process”).

One disadvantage of powder coating compositions has been that, to obtain various opaque coatings of different hues, it has been required to use the Extrusion Process to provide a separate powder coating composition for each desired hue. When liquid coating compositions of different opaque hues are mixed, it is possible to obtain an opaque coating having a homogeneous hue that is different from the hue of each mixed liquid coating composition. On the other hand, when typical powder coating compositions of different hues are simply dry-blended and the resultant blend applied to a substrate, the result is that each individual hue can be generally distinguished by visual examination with the naked eye, resulting in a “salt and pepper” or “graininess” effect.

One way to avoid the aforementioned effect is through the use of non-agglomerated nanopigments. These pigments, while capable of providing a coating of a desired homogeneous, i.e., uniform, hue from a dry blend mixture of two powder coating compositions of a different hue, typically result in the production of translucent (non-opaque) colored coatings. As a result, to hide a substrate, an opaque coating must be deposited prior to the deposition of a powder coating composition comprising a dry blend mixture of two powder coating compositions of a different hue which comprise non-agglomerated nanopigments.

Thus, it has previously been difficult, if not impossible, to achieve an opaque coating of a desired homogeneous hue from a dry blend of two or more powder coating compositions. As a result, the efficient production of small batches of opaque powder coating compositions having a desired color has been elusive.

Therefore, it would be desirable to provide a method of producing, in a single coating layer, an opaque coating having virtually any selected homogeneous hue, including bright hues as well as grays and pastels.

### BRIEF DESCRIPTION OF THE DRAWINGS

FIG. 1 is a plot of the ΔL* value (between the L* of the cured coating and the L* value of a cured coating deposited from the corresponding first coating composition alone) v. salt & pepper rating and shows the relationship between the two in Examples 16 and 23.

### SUMMARY OF THE INVENTION

In certain respects, the present invention is directed methods of making a powder coating composition that comprise mixing at least one first powder coating composition and at least one second powder coating composition. The at least one first powder coating composition, when deposited upon a substrate and cured, provides a cured coating having a first L* value and comprises opaque particulates comprising: (i) a film-forming resin; and (ii) an internal colorant. The at least one second powder coating composition comprises: (i) particulates comprising: (A) a film-forming resin; and (B) an internal colorant, and (ii) external colorant particles removably adhered to the particulates. In addition, the mixture, when deposited upon a substrate and cured, produces a coating having an L* value within 20 units of the first L* value.

In other respects, the present invention relates to powder coating compositions that can be produced by the foregoing methods. For example, in the case where the at least one second powder coating composition comprises translucent particulates, such powder coating compositions comprise: (a) opaque particulates comprising: (i) a film-forming resin; and (ii) an internal colorant; (b) translucent particulates comprising: (i) a film-forming resin; and (ii) an internal colorant; and (c) external colorant particles removably adhered to the opaque particulates and the translucent particulates. The powder coating composition, when deposited upon a substrate and cured, produces a coating having an L* value within 20 units of the L* value of a coating deposited from the opaque particulates alone. In the case where the at least one second powder coating composition comprises opaque particulates, such powder coating compositions comprise: (a) opaque particulates comprising: (i) a film-forming resin; and (ii) an internal colorant; and (b) external colorant particles removably adhered to the opaque particulates. The powder coating composition, when deposited upon a substrate and cured, produces a coating having an L* value within 20 units of the L* value of a coating deposited from the opaque particulates alone.

In still other respects, the present invention is directed to powder coating systems comprising: (a) at least one first powder coating composition comprising opaque particulates having a first hue; (b) at least one second powder coating composition comprising opaque particulates having a second hue different from the first hue; (c) at least one third powder coating composition comprising opaque particulates having a third hue different from the first and second hue; and (d) at least one fourth powder coating composition comprising translucent or opaque particulates having a fourth hue and having external colorant particles removably adhered thereto.

In yet other respects, the present invention is directed to methods for making an opaque coating having a preselected hue. These methods comprise: (a) mixing one or more first powder coating compositions and one or more second powder coating compositions to form a mixture; and (b) depositing the mixture onto a substrate to form an opaque coating having a homogenous hue wherein a ΔE between the hue of the coating and the preselected hue is no more than 1. In these methods: (a) the one or more first powder coating compositions, when deposited upon a substrate and cured, provides a cured coating having a first L* value and comprise opaque particulates comprising: (i) a film-forming resin; and (ii) an internal colorant; (b) the one or more second powder coating compositions comprise: (i) translucent or opaque particulates comprising: (A) a film-forming resin; and (B) an internal colorant; and (ii) external colorant particles removably adhered to the particulates. In addition, the mixture, when deposited upon a substrate and cured, produces a coating having an L* value within 20 units of the first L* value.

As will be appreciated from the description herein, the present invention is also directed to, inter cilia, related kits comprising the foregoing powder coating systems, related coated substrates and methods for coating a substrate.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As indicated above, certain embodiments of the present invention are directed to methods of making powder coating compositions that comprise mixing at least one first powder coating composition and at least one second powder coating composition. As used herein, the term “powder coating composition” refers to a composition comprising a film-forming resin that is suitable for producing a coating on a substrate, which is embodied in a solid particulate form, as opposed to liquid form. Such particulates may have a small particle size (less than 10 micron) or may be of larger particle sizes. In certain embodiments, the at least one first powder coating composition and the at least one second powder coating composition are both in the form of solid particulates having an average particle size from 0.3 to 300 microns, such as 1 to 100 microns, or, in some cases, 25 to 100 microns. In certain embodiments, the at least one first powder coating composition and the at least one second powder coating composition are in the form of solid particulates wherein a majority of the particulates, i.e., >50% by weight, have a particle size greater than 20 microns, in some cases, greater than 25 microns.

In certain embodiments, the at least one first powder coating compositions and the at least one second powder coating compositions described herein are suitable for producing a decorative and durable coating. As used herein, the term “decorative and durable coating” refers to a coating that is both decorative, i.e., it provides a desired appearance, and durable, i.e., it does not significantly chip, peel, mar, or delaminate when subjected to environmental conditions, such as humidity and abrasion typically experienced by a coating, such as coatings used on automotive and truck components, such as bodies, door panels, cabs, wheels and trailer bodies; airplane components, such as fuselage and wings; architectural components; household electrical and mechanical appliances; consumer electronic equipment, such as computers and telephones; as well as other articles.

In the methods of the present invention, the at least one first powder coating composition comprises particulates that are opaque, whereas the at least one second powder coating composition comprises particulates that are translucent or opaque. As used herein, when it is stated that powder coating composition particulates are “opaque” it means that the particulates produce a cured coating that hides an underlying surface when the coating has a dry film thickness of 80-110 microns. As used herein, “hides an underlying surface” means that the surface underlying the coating, such as, for example, a bare substrate itself or an underlying coating deposited over the substrate, is not visible to the naked eye when viewed at any distance. On the other hand, as used herein, when it is stated that powder coating composition particulates are “translucent” it means that the particulates produce a cured coating that does not hide an underlying surface when the coating has a dry film thickness of 80-110 microns.

In certain embodiments of the present invention, the at least one first powder coating composition comprises particulates that, when deposited upon a substrate and cured, produces a cured coating that has a hue selected from yellow, magenta, and cyan. As used herein, the term “hue” refers to the quality of a color as determined by its dominant wavelength (“DW”). Exemplary hues include yellow, magenta, cyan, blue, green, and red. As will be appreciated, yellow, magenta, and cyan are the three subtractive primary colors. In other words, mixing cyan, magenta and yellow together “subtracts” all wavelengths of visible light and results in a black hue. As used herein, “cyan” refers to a hue having a DW of 475 to 500 nanometers. As used herein, “yellow” refers to a hue having a DW of 565 to 590 nanometers. As used herein, magenta refers to a hue obtained from a substantially equal mixture of a red hue having a DW of 650 to 700 nanometers and a blue hue having a DW of 400 to 475 nanometers.

In the methods of the present invention, the at least one first powder coating composition and the at least one second powder coating composition comprise particulates comprising a film-forming resin. In certain embodiments, such a film-forming resin comprises a polymer having at least one type of reactive functional group and a curing agent having functional groups reactive with the functional group(s) of the polymer. As used herein, the term “polymer” is meant to encompass oligomers and, includes, for example, homopolymers and copolymers. The polymers can be, for example, acrylic, polyester, polyether, or polyurethane, and can contain functional groups, such as hydroxyl, carboxylic acid, carbamate, isocyanate, epoxy, amide, and carboxylate groups.

The use in powder coatings of acrylic, polyester, polyether, and polyurethane polymers having hydroxyl functionality is known in the art. Monomers for the synthesis of such polymers are typically chosen so that the resulting polymers have a glass transition temperature (“Tg”) greater than 50° C. Examples of such polymers are described in U.S. Pat. No. 5,646,228 at col. 5, line 1 to col. 8, line 7, the cited portion of which being incorporated herein by reference.

Acrylic polymers and polyester polymers having carboxylic acid functionality are also suitable. Monomers for the synthesis of acrylic polymers having carboxylic acid functionality are often chosen such that the resulting acrylic polymer has a Tg greater than 40° C. and for synthesis of polyester polymers having carboxylic acid functionality such that the resulting polyester polymer has a Tg greater than 50° C. Examples of carboxylic acid group-containing acrylic polymers are described in U.S. Pat. No. 5,214,101 at col. 2, line 59 to col. 3, line 23, the cited portion of which being incorporated herein by reference. Examples of carboxylic acid group-containing polyester polymers are described in U.S. Pat. No. 4,801,680 at col. 5, lines 38-65, the cited portion of which being incorporated herein by reference.

The carboxylic acid group-containing acrylic polymers can further contain a second carboxylic acid group-containing material selected from the class of C₄ to C₂₀ aliphatic dicarboxylic acids, polymeric polyanhydrides, low molecular weight polyesters having an acid equivalent weight from 150 to 750, and mixtures thereof. This material is crystalline and is often a low molecular weight crystalline or glassy carboxylic acid group-containing polyester.

Also useful are acrylic, polyester, and polyurethane polymers containing carbamate functional groups. Examples are described in WO Publication No. 94/10213. Monomers for synthesis of such polymers are often chosen so that the resulting polymer has a Tg of greater than 40° C. The Tg of all the polymers described herein can, as will be appreciated by the skilled artisan, be determined by differential scanning calorimetry (DSC).

Suitable curing agents generally include, for example, blocked isocyanates, polyepoxides, polyacids, polyols, anhydrides, polyamines, aminoplasts and phenoplasts. The appropriate curing agent can be selected by one skilled in the art depending on the polymer used. For example, blocked isocyanates are suitable curing agents for hydroxyl and primary and/or secondary amino group-containing materials. Examples of blocked isocyanates include those described in U.S. Pat. No. 4,988,793, at col. 3, lines 1 to 36, the cited portion of which being incorporated herein by reference. Polyepoxides suitable for use as curing agents for carboxylic acid functional group-containing materials are described in U.S. Pat. No. 4,681,111 at col. 6, line 45 to col. 9, line 54, the cited portion of which being incorporated herein by reference. Polyols, i.e., materials having an average of two or more hydroxyl groups per molecule, can be used as curing agents for isocyanate functional group-containing materials and anhydrides, as is known in the art, such polyols often selected such that the resultant material has a Tg greater than 30° C.

Anhydrides as curing agents for epoxy functional group-containing materials include, for example, trimellitic anhydride, benzophenone tetracarboxylic dianhydride, pyromellitic dianhydride, tetrahydrophthalic anhydride, and the like as described in U.S. Pat. No. 5,472,649 at col. 4, lines 49-52, the cited portion of which being incorporated herein by reference. Aminoplasts as curing agents for hydroxyl, carboxylic acid and carbamate functional group-containing materials are known and include, for example, aldehyde condensates of glycoluril, which give high melting crystalline products useful in powder coatings. While the aldehyde used is typically formaldehyde, other aldehydes such as acetaldehyde, crotonaldehyde, and benzaldehyde can be used.

In certain embodiments, the at least one first powder coating composition and the at least one second powder coating composition comprises particulates comprising from 50 to 95 percent by weight, such as 60 to 80 percent by weight, of the film-forming resin, based on the total weight of the particulates. When a curing agent is used, it is often present in an amount of up to 30 weight percent, based on the total weight of the particulates.

In certain embodiments, the at least one first powder coating compositions and the at least one second powder coating composition comprise the same film-forming resin and/or curing agent combination. In other embodiments, the at least one first powder coating compositions and the at least one second powder coating composition comprise a different film-forming resin and/or curing agent combination, so long as the compositions are compatible with each other as described below.

In the methods of the present invention, the at least one first powder coating composition and the at least one second powder coating composition comprise particulates comprising an internal colorant. As used herein, the term “colorant” refers to any substance that imparts color, opacity, or other visual effect to the composition. In certain embodiments, the colorant comprises color-imparting particles. As used herein, the term “color-imparting particle” refers to a particle that either (i) produces a particular hue by significantly absorbing some wavelengths of light in the visible region, that is, wavelengths ranging from 400 to 700 nanometers, more than it absorbs other wavelengths in the visible region; (ii) produces a white hue by scattering all wavelengths of light in the visible region in approximately equal proportions without preferentially absorbing any particular wavelengths in the visible region; or (iii) produces a black hue by absorbing all wavelengths of light in the visible region in approximately equal proportions.

As used herein, the term “internal colorant” refers to a colorant that is embedded within the powder coating composition particulates, i.e., the colorant is incorporated into the powder coating particulates via the Extrusion Process. In certain embodiments, the internal colorant is disposed predominantly or, in some cases, completely within a powder coating particulate. As used in this context, “predominantly” means that more than 50%, such as more than 60%, more than 70%, more than 80% or, in some cases, more than 90% of the surface area of a colorant particle is disposed within a powder coating composition particulate. As used herein, “completely” means that 100% of the surface area of a colorant particle is disposed within a powder coating particulate. As will be appreciated, such an “internal colorant”, since it is embedded within the powder coating particulates via the Extrusion Process, cannot be removed from the powder coating particulate by exposing the particulate to shear mixing conditions, as is the case with the “external colorant particles” described below.

In certain embodiments, the internal colorant comprises color-imparting particles having an average primary particle size of 0.05 to 2.0, such as 0.1 to 1.0, or, in some cases, 0.2 to 0.5 microns. For purposes of the present invention, average particle size can be measured according to known laser scattering techniques. For example, average particle size can be determined using a Horiba Model LA 900 laser diffraction particle size instrument, which uses a helium-neon laser with a wave length of 633 nm to measure the size of the particles and assumes the particle has a spherical shape, i.e., the “particle size” refers to the smallest sphere that will completely enclose the particle. Average particle size can also be determined by visually examining an electron micrograph of a transmission electron microscopy (“TEM”) image of a representative sample of the particles, measuring the diameter of the particles in the image, and calculating the average primary particle size of the measured particles based on magnification of the TEM image. One of ordinary skill in the art will understand how to prepare such a TEM image and determine the primary particle size based on the magnification. The primary particle size of a particle refers to the smallest diameter sphere that will completely enclose the particle. As used herein, the term “primary particle size” refers to the size of an individual particle.

The shape (or morphology) of the color-imparting particles can vary. For example, generally spherical morphologies can be used, as well as particles that are cubic, platy, or acicular (elongated or fibrous). Additionally, the particles can have an internal structure that is hollow, porous or void free, or a combination of any of the foregoing, e.g., a hollow center with porous or solid walls.

In certain embodiments, the color-imparting particles comprise an inorganic material. Suitable color-imparting particles can be formed from ceramic materials, metallic materials, and mixtures of any of the foregoing. Non-limiting examples of such ceramic materials can comprise metal oxides, mixed metal oxides, metal nitrides, metal carbides, metal sulfides, metal silicates, metal borides, metal carbonates, and mixtures of any of the foregoing. A specific, non-limiting example of a metal nitride is boron nitride; a specific, non-limiting example of a metal oxide is iron oxide; non-limiting examples of suitable mixed metal oxides are aluminum silicates and magnesium silicates; non-limiting examples of suitable metal sulfides are molybdenum disulfide, tantalum disulfide, tungsten disulfide, and zinc sulfide; non-limiting examples of metal silicates are aluminum silicates and magnesium silicates, such as vermiculite.

In certain embodiments, the color-imparting particles comprise inorganic materials selected from aluminum, barium, bismuth, boron, cadmium, calcium, cerium, cobalt, copper, iron, lanthanum, magnesium, manganese, molybdenum, phosphorus, selenium, silicon, silver, sulfur, tin, titanium, tungsten, vanadium, yttrium, zinc, and zirconium, including oxides thereof, nitrides thereof, phosphides thereof, phosphates thereof, selenides thereof, sulfides thereof, sulfates thereof, and mixtures thereof. Suitable non-limiting examples of the foregoing inorganic particles include alumina, silica, titania, ceria, zirconia, bismuth oxide, magnesium oxide, iron oxide, vanadium oxide, aluminum silicate, boron carbide, nitrogen doped titania, and cadmium selenide.

The color-imparting particles can be formed from organic materials. Non-limiting examples of organic materials useful in the present invention include, but are not limited to, stearates (such as zinc stearate and aluminum stearate), diamond, carbon black and stearamide.

In certain embodiments, the color-imparting particles comprise an organic pigment, such as for example, azo compounds (monoazo, di-azo, β-Naphthol, Naphthol AS, azo pigment lakes, benzimidazolone, di-azo condensation, metal complex, isoindolinone, isoindoline), and polycyclic (phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone) pigments, and mixtures of any of the foregoing. Specific examples of suitable materials are described in U.S. Pat. No. 6,585,817 at col. 5, lines 23 to 33 and United States Patent Application Publication No. 2002/0193514 A1 at [0031], the cited portions of which being incorporated herein by reference. In certain embodiments, the color-imparting particles comprise an organic pigment selected from Pigment Black 7, a copper containing phthalocyanine pigment, such as Pigment Blue 15, (including Pigment Blue 15:1, Pigment Blue 15:2, Pigment Blue 15:3, Pigment Blue 15:4, and Pigment Blue 15:6), a metal-containing phthalocyanine pigment based on, for example, zinc, cobalt, iron, nickel, and the like, a metal-free phthalocyanine pigment, Pigment Blue 60, Pigment Green 7, Pigment Green 36, Pigment Red 101, Pigment Red 122, Pigment Red 168, Pigment Red 170, Pigment Red 179, Pigment Red 188, Pigment Red 202, Pigment Red 209, Pigment Red 264, Pigment Violet 19, Pigment Violet 29, Pigment Yellow 42, Pigment Yellow 74, Pigment Yellow 83, Pigment Yellow 109, Pigment Yellow 110, Pigment Yellow 128, Pigment Yellow 129, Pigment Yellow 138, Pigment Yellow 139, Pigment Yellow 150, Pigment Yellow 154, Pigment Yellow 175, Pigment Yellow 180, Pigment Yellow 181, Pigment Yellow 184, and/or Pigment Yellow 213.

In certain embodiments, the color-imparting particles comprise a particulate dye, such as, but not limited to, the examples described in U.S. Pat. No. 4,803,150 at col. 5, line 27 to col. 11, line 40, the cited portion of which being incorporated herein by reference.

In certain embodiments, particularly in the case of opaque particulates, the internal colorant comprises a combination of a hiding pigment and a transparent or semi-transparent colorant. Examples of hiding pigments include any of those well known to those skilled in the art and specifically include, without limitation, titanium dioxide, zinc oxide, antimony oxide, etc. Suitable transparent and semi-transparent colorants include various inorganic and organic pigments described herein and typically exhibit a hue such as yellow, cyan, red, magenta, orange, blue, violet, or green. In certain embodiments, the internal colorant comprises a hiding pigment and an transparent and/or semi-transparent colorant wherein the weight ratio thereof is within the range of 0.1 to 10:1, such as 0.3 to 5:1.

In certain embodiments, the internal colorant is present in the at least one first powder coating composition particulates and the at least one second powder coating composition particulates in an amount of 0.1 to 40, such as 1 to 30, 1 to 15, or, in some cases 3 to 15 percent by weight, based on the total weight of the particulates.

The at least one first powder coating composition and the at least one second powder coating composition can optionally include other additives, such as waxes for flow and wetting, flow control agents, such as poly(2-ethylhexyl)acrylate, degassing additives such as benzoin and MicroWax C, anti-oxidants, ultraviolet (UV) light absorbers and catalysts. Examples of useful anti-oxidants and UV light absorbers include those commercially available from Ciba Specialty Chemicals Corporation under the trademarks IRGANOX and TINUVIN. These optional additives, when used, are often present in amounts up to 20 percent by weight, based on total weight of the particulates.

Such powder coating compositions may also include fumed silica or the like to reduce caking of the powder during storage. An example of a fumed silica is sold by Cabot Corporation under the trademark CAB-O-SIL. The fumed silica is present in amounts ranging from 0.1 to 1 percent by weight based on total weight of the particulates.

The particulates of the at least one first powder coating composition and the at least one second powder coating composition can be prepared by any of a variety of methods, however, in certain embodiments, such particulates are prepared by the Extrusion Process described earlier comprising: (i) dry blending in, for example, a Henschel blade blender, the various coating components, such as film-forming resins, curing agents, colorants, and other additives, such as flow control agents and the like, for a period of time sufficient to result in an adequate dry blend of the components, (ii) subjecting the resulting blend to heating, melting and kneading by the use of an extruder, such as a twin screw co-rotating extruder operated within a temperature range sufficient to melt but not gel the components, and then (iii) subjecting the resulting extrudate to cooling, grinding and classification. The Examples set forth herein below further describe suitable methods for making such powder coating composition particulates. In the cases where the at least one second powder coating compositions comprise translucent particulates, such powder coating compositions can be prepared, for example, by using polymer-enclosed substantially non-agglomerated nanopigments, such as is described in U.S. Pat. No. 7,605,194 at col. 8, line 58 to col. 18, line 33, the cited portion of which being incorporated herein by reference.

In the methods of the present invention, in addition to the foregoing particulates, the at least one second powder coating composition (and optionally the at least one first powder coating composition) has external colorant particles removably adhered to the particulates. As used herein, the term “external colorant particles” refers to particles that are disposed on the surface of the powder coating particulates, as opposed being incorporated into, i.e., embedded within, the particulates (as is the case with the previously described internal colorant). In certain embodiments, the external colorant particles are disposed predominantly or, in some cases, completely on the surface of a powder coating composition particulate. In this context, “predominantly” means that more than 50%, such as more than 60%, more than 70%, more than 80% or, in some cases, more than 90% of the surface area of a colorant particle is disposed on the surface of a powder coating particulate. In this context, “completely” means that 100% of the surface area of a colorant particle is disposed on the surface of a powder coating particulate.

As used herein, the term “removably adhered” means that the external colorant particle is bound to at least one surface of the powder coating particulate, such as by, for example, surface tension, electrostatic or other physical attachment means, sufficiently such that the external colorant particles will not significantly separate from the powder coating particulate if the powder coating composition were to be applied to a substrate by electrostatic spray coating or fluidized bed coating techniques, but can be removed from the powder coating particulate and redistributed if the composition is exposed to shear mixing conditions, such as would be provided by a high-intensity or medium-intensity mixer having rotating blades, such as the mixers described in U.S. Pat. No. 5,187,220 at col. 5, lines 30-44 and U.S. Pat. No. 3,632,369 at col. 4, lines 45 to 55, the cited portions of which being incorporated herein by reference. Suitable shear mixing conditions are also described in the Examples herein. Electrostatic spray coating and fluidized bed coating techniques are described in U.S. Pat. No. 6,162,856 at col. 1, lines 40-59, the cited portion of which being incorporated herein by reference.

In certain embodiments, the external colorant particles have an average primary particle size of 0.05 to 2.0, such as 0.1 to 1.0, or, in some cases, 0.2 to 0.5 microns, Suitable materials for use as the external colorant particles include any of the color-imparting particles described earlier with respect to the internal colorant.

In certain embodiments of the methods of the present invention, the external colorant particles removably adhered to the at least one second powder coating composition particulates are the same as the internal colorant of the second powder coating composition particulates to which they are removably adhered. In some embodiments, the external colorant particles removably adhered to the at least one second powder coating composition particulates are different from the internal colorant of the second powder coating composition particulates to which they are removably adhered

In certain embodiments, the weight ratio of external colorant particles to powder coating composition particulates to which such external colorant particles are removably adhered is from 0.01 to 1:1, such as 0.1 to 1:1, 0.1 to 0.5:1, or 0.2 to 0.4:1.

The Examples herein describe a suitable method for making a powder coating composition suitable for use in the methods of the present invention, wherein external colorant particles are removably adhered to powder coating composition particulates. This can be accomplished by, for example, mixing powder coating composition particulates with color-imparting particles, which are often in the form of dry agglomerates wherein several color-imparting particles are clustered together, using a high-intensity or medium-intensity mixer having rotating blades, such as, for example, a Henchsel mixer, as well as mixers of the general type described in U.S. Pat. No. 5,187,220 at col. 5, lines 30-44 and U.S. Pat. No. 3,632,369 at col. 4, lines 45 to 55, the cited portions of which being incorporated herein by reference. As indicated, the color-imparting particles are typically in dry form, as opposed to a liquid dispersion of such particles. Such mixing often takes place below the glass transition temperature of the powder coating composition particulates and can take place, for example, at ambient conditions of temperature and pressure and may continue for any suitable period of time, such as 15 seconds to 1 hour, in some cases 15 seconds to 10 minutes depending upon the mixer tip speed, colorants and powder coating composition particulates. The appropriate mixing conditions and time can be determined by the skilled artisan through routine experimentation to achieve color-imparting particles removably adhered to powder coating composition particulates.

In order to provide the capability to produce coatings of almost any desired color, it may be desirable to employ a powder coating system, suitable for use in the methods of the present invention, which comprises a plurality of powder coating compositions comprising opaque particulates of different hues and at least one powder coating composition comprising translucent or opaque particulates having external colorant particles removably adhered thereto. As used herein, the term “powder coating system” refers to a plurality of powder coating compositions suitable for use with each other. This means that the powder coating system comprises a plurality of powder coating compositions that are compatible with each other in terms of their ability to be mixed together, as described herein, to provide a mixture that can be deposited onto a substrate and cured to provide a decorative and durable coating. Often, the powder coating compositions will comprise one or more identical or similar components, such as identical or similar film-forming resins, including reactive functional group containing polymer/curing agent combinations. It will be appreciated, however, that this is not necessarily the case, so long as the powder coating compositions are sufficiently compatible with each other so that the desired result, which is a decorative and durable opaque coating having a desired homogeneous hue, can be achieved.

More specifically, in some cases, the powder coating system includes at least three different powder coating compositions comprising opaque particulates of different hues, such as where at least one powder coating composition comprises particulates having a yellow hue, at least one powder coating composition comprises particulates having a magenta hue, and at least one powder coating composition comprises particulates having a cyan hue. Moreover, if desired, additional powder coating compositions comprising opaque particulates may be included in the powder coating systems of the present invention. Such additional first powder coating compositions may comprise particulates having, for example, a blue hue (a hue having a DW of 400 to 475 nanometers), a green hue (a hue having a DW of 500 to 565 nanometers), and/or a red hue (a hue having a DW of 650 to 700 nanometers).

In some cases, the powder coating system may include at least three different first powder coating compositions comprising opaque particulates having a first hue, such as a yellow hue, at least one of which, when deposited upon a substrate and cured, produces a coating having an L* value of at least 70, at least one of which, when deposited upon a substrate and cured, produces a coating having an L* value of greater than 30 to less than 70, and at least one of which, when deposited upon a substrate and cured, produces a coating having an L* value of no more than 30. Similarly, in some cases, the powder coating system may include at least three different first powder coating compositions comprising opaque particulates having a second hue different from the first hue, such as a magenta hue, at least one of which, when deposited upon a substrate and cured, produces a coating having an L* value of at least 70, at least one of which, when deposited upon a substrate and cured, produces a coating having an L* value of greater than 30 to less than 70, and at least one of which, when deposited upon a substrate and cured, produces a coating having an L* value of no more than 30. In addition, in some cases, the powder coating system may include at least three different first powder coating compositions comprising opaque particulates having a third hue different from the first hue and the second hue, such as a cyan hue, at least one of which, when deposited upon a substrate and cured, produces a coating having an L* value of at least 70, at least one of which, when deposited upon a substrate and cured, produces a coating having an L* value of greater than 30 to less than 70, and at least one of which, when deposited upon a substrate and cured, produces a coating having an L* value of no more than 30. As will be appreciated, the L* value of a coating can be increased by the inclusion of light, such as white, colorants (such as titanium dioxide) and the L* value of a coating can be deceased by the inclusion of dark, such as black, colorants (such as carbon black). As will be appreciated, in the CIELAB color-measuring system, the L* value is associated with a central vertical axis that represents lightness and darkness, the lightest (white) being L*=100 and the darkest (black) being L*=0. As used herein, an “L* value” refers to the maximum L* value of a coating when measured at any viewing angle from 110° to −15° using a multi-angle spectrophotometer, such as an MA68II Multi-angle spectrophotometer, commercially available from X-Rite Instruments, Inc.

The powder coating systems described herein comprise at least one fourth powder coating composition comprising translucent or opaque particulates having a fourth hue, such as a yellow hue, and having external colorant particles removably adhered thereto. Moreover, such powder coating system may include at least one fifth powder coating composition comprising translucent or opaque particulates having a fifth hue different from the fourth hue, such as a magenta hue, and external colorant particles removably adhered thereto, and at least one sixth powder coating composition comprising translucent or opaque particulates having a sixth hue different from the fourth hue and the fifth hue, such as a cyan hue, and external colorant particles removably adhered thereto.

For example, and without limitation, when the powder coating systems of the present invention comprise at least one powder coating composition comprising opaque particulates having a yellow hue, the powder coating systems may comprise at least one powder coating composition comprising (i) translucent or opaque particulates having a yellow hue, and (ii) an external colorant comprising particles removably adhered to at least one surface of the particulates and having a hue different from a yellow hue. Also, and without limitation, when the powder coating systems comprise at least one powder coating composition comprising opaque particulates having a cyan hue, the powder coating systems may comprise at least one powder coating composition comprising (i) translucent or opaque particulates having a cyan hue, and (ii) an external colorant comprising particles removably adhered to at least one surface of the particulates and having a hue different from a cyan hue. In addition, and without limitation, when the powder coating systems comprise at least one powder coating composition comprising opaque particulates having a magenta hue, the powder coating systems may also comprise at least one powder coating composition comprising (i) translucent or opaque particulates having a magenta hue, and (ii) an external colorant comprising particles removably adhered to at least one surface of the particulates and having a hue different from a magenta hue. As a result, by appropriate selection of mixtures of powder coating compositions a resulting powder coating composition having nearly any desired hue can be obtained.

In addition, in certain embodiments, to produce coatings having a desired level of lightness or darkness or other attribute, the powder coating systems also may comprise at least one powder coating composition comprising particulates having a white hue, at least one powder coating composition comprising particulates having a black hue, and at least one powder coating composition comprising colorless translucent particulates. As used herein, the term “black hue” refers to the color produced by a material that absorbs all wavelengths of light in the visible region in approximately equal proportions. As used herein, the term “white hue” refers to the color produced by a material that randomly reflects and scatters all wavelengths of light in the visible region without preferentially absorbing any particular wavelength of light in the visible region.

In certain embodiments, the one or more first powder coating compositions and the one or more second powder coating compositions described herein are substantially, or, in some cases, completely free of any bleeding dyes and/or pigments, such as the materials described in EP 0 724 611 B2 at [0025] to [0029], the cited portion of which being incorporated herein by reference. In certain embodiments, the one or more first powder coating compositions and the one or more second powder coating compositions described herein are substantially, or, in some cases, completely free of any magenta and/or cyan pigment treated with aluminum oxide or silica as described in JP 2008-031286A at [0017] to [0019], the cited portion of which being incorporated herein by reference. As used herein, unless otherwise indicated, the term “substantially free” means that the material being discussed is present in another substance, if at all, as an incidental impurity. In other words, the material does not effect the properties of the other substance. As used herein, the term “completely free” means that the material is not present in the other substance at all.

It has been discovered, surprisingly, that when the powder coating systems of the present invention are used in a certain manner, it is possible to produce an opaque coating having almost any preselected homogeneous hue from a mixture of two or more appropriately selected powder coating compositions. As used herein, “homogenous hue” means that the coating is recognized by a person as having an essentially uniform hue when viewed with the naked eye at a distance of at least 6 inches from the coating. It has been discovered that this can often be accomplished by appropriate selection of the L* value of the powder coating compositions to be mixed, as described in more detail below.

Moreover, such mixtures can produce coatings exhibiting bright and brilliant colors, as well as gray and pastels, if desired. Indeed, such results can be obtained because the present powder coating systems do not require, and often desirably do not include, the use of any powder coating compositions that utilize an external colorant comprising white pigment particles in any significant amount, such as is required in other powder coloring systems described in the prior art, and the use of which has the significant drawback of “washing out” the color of external colorant particles, such that only pastels or grays can be produced.

In certain embodiments, therefore, at least one, in some cases all, of the powder coating compositions described above are substantially free or, in some cases, completely free of non-incorporated white pigment. In this context, “substantially free” means that such powder coating compositions have less than 1 percent by weight, such as no more than 0.9 percent by weight, no more than 0.5 percent by weight, or, in some cases, no more than 0.1 percent by weight of non-incorporated white pigment, based on the total weight of the powder coating composition. In this context, “completely free” means that the powder coating composition has no non-incorporated white pigment at all. As used herein, “non-incorporated white pigment” means white pigment means white pigment distributed on the surface of powder coating composition particulates.

As indicated, the methods of the present invention comprise mixing at least one first powder coating composition and at least one second powder coating compositions to form a mixture thereof. The mixing acts to re-distribute the external colorant particles so that they are removably adhered to the particulates of the at least one first powder coating composition and the at least one second powder coating composition. Ideally, but not necessarily, the mixing distributes the external colorant particles substantially equally on the at least one first powder coating composition opaque particulates and the at least one second powder coating composition translucent or opaque particulates.

As a result, the present invention is also directed to powder coating compositions that result from such mixing. In certain embodiments, particularly those in which the second powder coating composition comprises translucent particulates, these powder coating compositions comprise: (a) opaque particulates comprising: (i) a film-forming resin; and (ii) an internal colorant; (b) translucent particulates comprising: (i) a film-forming resin; and (ii) an internal colorant; and (c) external colorant particles removably adhered to the opaque particulates and the translucent particulates. In other embodiments, particularly those in which the second powder coating composition comprises opaque particulates, these powder coating compositions comprise: (a) opaque particulates comprising: (i) a film-forming resin; and (ii) an internal colorant; and (b) external colorant particles removably adhered to the opaque particulates. In addition, in each of these embodiments (particularly those in which the second powder coating composition comprises opaque particulates) it may be desirable that substantially all of the opaque particulates in the powder coating composition are of the same hue. In this context, “substantially all” means that at least 90% by weight, such as at least 95% by weight or at least 99% by weight of all of the opaque particulates present in the powder coating composition are of the same hue.

Moreover, as indicated, it has been surprisingly discovered that, by appropriate selection of the at least one first powder coating composition and the at least one second powder coating composition to be mixed, and the L* value of the powder coating compositions to be mixed, it is possible to produce an opaque coating having almost any preselected homogeneous hue from a dry blend mixture of two or more appropriately selected powder coating compositions.

Thus, in certain methods of the present invention, the mixture of at least one first powder coating composition and the at least one second powder coating composition, when deposited upon a substrate and cured, produces a cured coating having an L* value within 20 units, in some cases within 15 units, within 10 units, or within 5 units, of the L* value of a cured coating that would be produced from the at least one first powder coating composition used in the method, if such at least one first powder coating composition alone were deposited upon and substrate and cured. It has been surprisingly discovered that these relationships can be critical to producing an opaque coating having a homogeneous hue according to the methods of the present invention. In addition, to ensure the opacity of the resulting coating, in certain of these methods, the mixture comprises no more than 20% by weight, such as no more than 15% by weight, or, in some cases, no more than 12% by weight of translucent particulates, based on the total weight of the mixture.

Another advantage of certain of the methods of the present invention is that relatively small amounts of external colorant particles can be used, while still achieving the desired results of an opaque coating having a desired homogeneous hue. This is important because large amounts of external colorant particles can be detrimental to important final coating properties, such as initial gloss, solvent resistance, and gloss retention after UV exposure, as illustrates in some of the Examples. In certain embodiments, therefore, the external colorant particles are present in the mixture in an amount of 0.01 to 10 percent by weight, such as 0.1 to 5 percent by weight, or, in some cases, 0.1 to 2 percent by weight, or, in yet other cases, 0.1 to 1 percent by weight or 0.1 to 0.5 percent by weight, based on the total weight of the mixture of at least one first powder coating composition and at least one second powder coating compositions.

The Examples herein describe suitable conditions for carrying out the methods of the present invention. In certain embodiments, the at least one first powder coating composition and the at least one second powder coating composition are combined in a mixer in a selected weight ratio depending on the particular composition of each and the ultimate hue desired. The powder coating compositions are then subjected to dry blend mixing. Suitable mixers for this purpose include the high-intensity and medium-intensity mixers having rotating blades, such as those described above. Such mixing can take place, for example, at ambient conditions of temperature and pressure and may continue for any suitable period of time, such as 15 seconds to 1 hour, in some cases 15 seconds to 10 minutes depending upon the mixer tip speed and powder coating compositions.

As indicated, in the methods of the present invention, the foregoing mixing distributes the external colorant particles so that they are removably adhered to the at least one first powder coating composition particulates and the at least one second powder coating composition particulates. In some cases, the external colorant particles are removably adhered substantially equally on the at least one first powder coating composition particulates and the at least one second powder coating composition particulates. As used herein, “substantially equally” means that the external colorant particles are adhered to the surface of all powder coating composition particulates in relative amounts such that the resulting mixture, after the optional fusion step described below and direct deposition on a substrate and cure, produces a cured opaque coating having a desired homogeneous hue which may be different from the hue of the at least one first powder coating composition particulates and/or different from the hue of the at least one second powder coating composition particulates. As used herein, “direct deposition” means that the mixture has not been subjected to the Extrusion Process, or any other processing steps, prior to application. As used herein, the term “mixture” refers to a heterogeneous association of the at least one first powder coating composition particulates and the at least one second powder coating composition particulates, wherein the powder coating compositions particulates are not permanently agglomerated or chemically combined and can be separated by mechanical means. It has been discovered that by producing first powder coating compositions comprising opaque particulates and second powder coating compositions comprising translucent or opaque particulates of a limited number of colors (fundamental colors) and by examining, in advance, the relation between the proportions of these powder coating compositions and the hues of the opaque coatings obtained therefrom, a powder coating composition of virtually any desired hue can be produced by appropriately selecting the at least one first powder coating compositions and the at least one second powder coating compositions and mixing them in the proper proportion so as to give a cured coating having a desired homogeneous opaque hue without the need to subject the mixture to the Extrusion Process or any other processing, save for the optional fusing step described below.

In certain embodiments, it is desirable to further permanently adhere the external colorant particles to the powder coating particulates of the resultant mixture. As used herein, “permanently adhere” means that the external colorant particles can no longer be removed from the powder coating particulate if the composition is exposed to shear mixing conditions, such as those described earlier. In certain embodiments, this is accomplished by a bonding process normally used in the powder coatings art for permanently adhering metallic flake pigments to powder coating particulates. This process entails mixing powder coating composition particulates comprising the external colorant particles at an elevated temperature based on the properties of the resin present in the powder coating composition, so as to soften a surface of the powder coating composition and thereby fuse the external colorant particles to the powder coating particulates. An example of such a process is described in, for example, U.S. Pat. No. 5,187,220, which is incorporated herein by reference.

The powder coating composition mixture described herein is suitable for deposition to any of a variety of substrates, including human and/or animal substrates, such as keratin, fur, skin, teeth, nails, and the like, as well as plants, trees, seeds, agricultural lands, such as grazing lands, crop lands and the like; turf-covered land areas, e.g., lawns, golf courses, athletic fields, etc., and other land areas, such as forests and the like.

Suitable substrates include cellulosic-containing materials, including paper, paperboard, cardboard, plywood and pressed fiber boards, hardwood, softwood, wood veneer, particleboard, chipboard, oriented strand board, and fiberboard. Such materials may be made entirely of wood, such as pine, oak, maple, mahogany, cherry, and the like. In some cases, however, the materials may comprise wood in combination with another material, such as a resinous material, i.e., wood/resin composites, such as phenolic composites, composites of wood fibers and thermoplastic polymers, and wood composites reinforced with cement, fibers, or plastic cladding.

Suitable metallic substrates include, but are not limited to, foils, sheets, or workpieces constructed of cold rolled steel, stainless steel and steel surface-treated with any of zinc metal, zinc compounds and zinc alloys (including electrogalvanized steel, hot-dipped galvanized steel, GALVANNEAL steel, and steel plated with zinc alloy), copper, magnesium, and alloys thereof, aluminum alloys, zinc-aluminum alloys such as GALFAN, GALVALUME, aluminum plated steel and aluminum alloy plated steel substrates may also be used. Steel substrates (such as cold rolled steel or any of the steel substrates listed above) coated with a weldable, zinc-rich or iron phosphide-rich organic coating are also suitable for use in the process of the present invention. Such weldable coating compositions are disclosed in, for example, U.S. Pat. Nos. 4,157,924 and 4,186,036. Cold rolled steel is also suitable when pretreated with, for example, a solution selected from the group consisting of a metal phosphate solution, an aqueous solution containing at least one Group IIIB or IVB metal, an organophosphate solution, an organophosphonate solution, and combinations thereof. Also, suitable metallic substrates include silver, gold, and alloys thereof.

Examples of suitable silicatic substrates are glass, porcelain and ceramics.

Examples of suitable polymeric substrates are polystyrene, polyamides, polyesters, polyethylene, polypropylene, melamine resins, polyacrylates, polyacrylonitrile, polyurethanes, poly/carbonates, polyvinyl chloride, polyvinyl alcohols, polyvinyl acetates, polyvinylpyrrolidones and corresponding copolymers and block copolymers, biodegradable polymers and natural polymers—such as gelatin.

Examples of suitable textile substrates are fibers, yarns, threads, knits, wovens, nonwovens and garments composed of polyester, modified polyester, polyester blend fabrics, nylon, cotton, cotton blend fabrics, jute, flax, hemp and ramie, viscose, wool, silk, polyamide, polyamide blend fabrics, polyacrylonitrile, triacetate, acetate, polycarbonate, polypropylene, polyvinyl chloride, polyester microfibers and glass fiber fabric.

Examples of suitable leather substrates are grain leather (e.g. nappa from sheep, goat or cow and box-leather from calf or cow), suede leather (e.g. velours from sheep, goat or calf and hunting leather), split velours (e.g. from cow or calf skin), buckskin and nubuk leather; further also woolen skins and furs (e.g. fur-bearing suede leather). The leather may have been tanned by any conventional tanning method, in particular vegetable, mineral, synthetic or combined tanned (e.g. chrome tanned, zirconyl tanned, aluminium tanned or semi-chrome tanned). If desired, the leather may also be re-tanned; for re-tanning there may be used any tanning agent conventionally employed for re-tanning, e.g. mineral, vegetable or synthetic tanning agents, e.g., chromium, zirconyl or aluminium derivatives, quebracho, chestnut or mimosa extracts, aromatic syntans, polyurethanes, (co)polymers of (meth)acrylic acid compounds or melamine, dicyanodiamide and/or urea/formaldehyde resins.

Examples of suitable compressible substrates include foam substrates, polymeric bladders filled with liquid, polymeric bladders filled with air and/or gas, and/or polymeric bladders filled with plasma. As used herein the term “foam substrate” means a polymeric or natural material that comprises a open cell foam and/or closed cell foam. As used herein, the term “open cell foam” means that the foam comprises a plurality of interconnected air chambers. As used herein, the term “closed cell foam” means that the foam comprises a series of discrete closed pores. Example foam substrates include polystyrene foams, polymethacrylimide foams, polyvinylchloride foams, polyurethane foams, polypropylene foams, polyethylene foams, and polyolefinic foams. Example polyolefinic foams include polypropylene foams, polyethylene foams and/or ethylene vinyl acetate (EVA) foam. EVA foam can include flat sheets or slabs or molded EVA forms, such as shoe midsoles. Different types of EVA foam can have different types of surface porosity. Molded EVA can comprise a dense surface or “skin”, whereas flat sheets or slabs can exhibit a porous surface.

The mixture is most often applied by spraying, and in the case of a metal substrate, by electrostatic spraying, or by the use of a fluidized bed. The mixture can be applied in a single sweep or in several passes to provide a film having a thickness after cure of from, for example, 1 to 10 mils, such as 2 to 4 mils, or about 3 mils.

In certain embodiments, after application of the mixture, the coated substrate is baked at a temperature sufficient to cure the coating. Metallic substrates with powder coatings, for example, are often cured at a temperature ranging from 230° F. to 650° F. for 30 seconds to 30 minutes.

As should also be appreciated from the foregoing description, the present invention is also directed to powder coatings systems as described above that are embodied in the form of a kit. As used herein, the term “kit” refers to a collection of articles usable together. In these embodiments, each of the powder coating compositions described above are stored in a different container. As a result, in certain embodiments, the present invention is directed to a kit comprising: (a) one or more first containers comprising a first powder coating composition described herein; and (b) one or more second containers comprising a second powder coating composition described herein.

In addition, the present invention is directed to methods for making an opaque coating having a preselected hue. These methods comprise: (a) mixing one or more first powder coating compositions and one or more second powder coating compositions to form a mixture; and (b) depositing the mixture onto a substrate to form an opaque coating having a homogenous hue wherein a ΔE between the hue of the coating and the preselected hue is no more than 1, in some cases no more than 0.8. In these methods: (a) the one or more first powder coating compositions, when deposited upon a substrate and cured, provides a cured coating having a first L* value and comprise opaque particulates comprising: (i) a film-forming resin; and (ii) an internal colorant; (b) the one or more second powder coating compositions comprise: (i) translucent or opaque particulates comprising: (A) a film-forming resin; and (B) an internal colorant; and (ii) external colorant particles removably adhered to the particulates. In addition, the mixture, when deposited upon a substrate and cured, produces a coating having an L* value within 20 units of the first L* value. According to the method, therefore, a preselected hue, or hue of a preselected coating, is determined by measuring the absorbance or reflectance of the preselected coating across the wavelengths corresponding to visible light. In some cases, the absorbance or reflectance of the preselected hue is determined using a spectrophotometer and a curve of the absorbance or reflectance across the range of wavelengths corresponding to visible light is produced. The curve is referred to as the visible absorbance or reflectance spectrum. A powder coating composition is prepared as described herein to produce an opaque colored coating having a visible absorbance or reflectance spectrum closely matching that of the preselected hue.

Illustrating the invention are the following examples that are not to be considered as limiting the invention to their details. All parts and percentages in the examples, as well as throughout the specification, are by weight unless otherwise indicated.

### Example 1

### Preparation of Powder Coating Composition Intermediate

This example describes the preparation of a core formula of dry materials used to make the powder coating compositions of the subsequent Examples. The core formula was prepared from the ingredients of Table 1 in the ratios indicated. Components 1 to 7 were premixed in a Henschel Blender. The mixture was then extruded through a Coperion W&P 30 mm co-rotating twin screw extruder. The extrudate was cooled and ground in a mechanical milling system to a particle size of about 28 to 30 microns, Oversized particles were removed and component 8 was added.

TABLE 1

| Component | Ingredients | Parts by Weight |
|---|---|---|
| 1 | Songnox 1076 PW¹ | 1.69 |
| 2 | Araldite GT 9654-1² | 32.81 |
| 3 | Powdermate EX2099³ | 1.47 |
| 4 | Byk-LP G 20547⁴ | 0.44 |
| 5 | Benzoin⁵ | 0.69 |
| 6 | Uralac P 6040⁶ | 60.85 |
| 7 | Joncryl 819⁷ | 1.97 |
| 8 | Aluminum Oxide-C⁸ | 0.08 |

¹Commercially available from Songwon
²Commercially available from Palmer Supplies
³Commercially available from Troy Corporation
⁴Commercially available from Byk Chemie
⁵Commercially available from GCA Chemical
⁶Commercially available from DSM Resins
⁷Commercially available from BASF Corporation
⁸Commercially available from Huntsman Advanced Materials

### Example 2

### Preparation of Powder Coating Composition Containing Opaque Particulates

Powder coating compositions were prepared from the powder coating composition intermediate of Example 1 and pigments in the amounts (grams) shown in Table 2. The powder coating compositions was prepared by vigorously shaking the intermediate and pigments in a bag for 20 seconds. The powder composition was then extruded using an APV MP19PC co-rotating twin screw extruder. The extrudate was cooled and then ground in a MIKRO-ACM™ Model 1 AOM milling system to a particle size of about 30-35 microns.

TABLE 2

| | 2A | 2B | 2C | 2D | 2E | 2F |
|---|---|---|---|---|---|---|
| Powder of Example 1 | 975.0 | 970.0 | 881.2 | 622.6 | 959.4 | 967.5 |
| TiO₂⁹ | 20.0 | 20.0 | 47.6 | 15.5 | 10.0 | 20.0 |
| PB15:3¹⁰ | 5.0 | | | | | 2.5 |
| PR122¹¹ | | 10.0 | | | | 10.0 |
| PY184¹² | | | 61.7 | | | |
| Yellow Iron Oxide¹³ | | | 9.5 | | 24.5 | |
| Barium Sulfate¹⁴ | | | | 348.0 | | |
| PR170¹⁵ | | | | 12.2 | | |
| Red Iron Oxide¹⁶ | | | | 1.7 | | |
| PG36¹⁷ | | | | | 3.4 | |
| PG7¹⁸ | | | | | 2.7 | |

⁹Titanium dioxide pigment, Tiona 595, available from Millenium
¹⁰Pigment Blue 15:3 Cu-Phthalocyanine (β), L7081D Heliogen Blue, available from BASF
¹¹Pigment Red 122, Hostaperm Pink EB, available from ClariantPigments
¹²Pigment Yellow 184, L1100 Sicopal Yellow, available from BASF
¹³Yellow Iron Oxide, Colortherm 10 Yellow Iron Oxide, available from Lanxess
¹⁴Barium Sulfate, Barimite XF, available from Cimbar Performance Minerals
¹⁵Pigment Red 170, Novaperm Red F2RK-70, available from Clariant Pigments
¹⁶Red Iron Oxide, R-8098 Pure Red, available from Rockwood Pigments
¹⁷Pigment Green 36, Monolite Green 860, available from Heucotech
¹⁸Pigment Green 7, 264-8143 Sunfast Green 7, available from Sun Chemical

### Example 3

### Preparation of Powder Coating Compositions Containing Translucent Particulates Having External Colorant Particles Removably Adhered Thereto

Cyan, magenta, and yellow powder coating compositions were prepared from translucent powder coating compositions and various pigments in the amounts (grams) shown in Table 3. Each of the three powder coating compositions was prepared by vigorously shaking the translucent powder coating particulates and pigments in a bag for 20 seconds.

TABLE 3

| | Cyan | Magenta | Yellow | | | |
|---|---|---|---|---|---|---|
| Pow- | Pow- | Pow- | Pow- | | | |
| der | der¹⁹ | der²⁰ | der²¹ | PB15:3¹⁰ | PV19²² | PY110²³ |
| 3A | 900.0 | | | 100.0 | | |
| 3B | | 90.0 | | | 10.0 | |
| 3C | | | 900.0 | | | 100.0 |

¹⁹Translucent cyan powder coating, 355-1059, commercially available from PPG Industries
²⁰Translucent magenta powder coating, 356-1088, commercially available from PPG Industries
²¹Translucent yellow powder coating, 353-1032, commercially available from PPG Industries
²²Pigment Violet 19, Cinquasia Red Y RT-759D, commercially available from Ciba
²³Pigment Yellow 110 Isoindolinone, Irgazin 3RTLN, available from Ciba Pigments

### Example 4

Preparation of Dry Blend Mixtures of First Powder Coating Compositions Containing Opaque Particulates and Second Powder Compositions Containing Translucent Particulates Having External Colorant Particles Removably Adhered Thereto

Fifteen powder coating compositions were prepared from the powder coating compositions of Examples 2A and 3 in the amounts (grams) shown in Table 4. Each of the fifteen powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 2.

TABLE 4

| | Powder of | | | Powder of |
|---|---|---|---|---|
| Powder | Ex. 2A | Powder of Ex. 3A | Powder of Ex. 3B | Ex. 3C |
| 4A | 63.0 | | 7.0 | |
| 4B | 52.5 | | 17.5 | |
| 4C | 63.0 | 7.0 | | |
| 4D | 52.5 | 17.5 | | |
| 4E | 63.0 | | | 7.0 |
| 4F | 52.5 | | | 17.5 |
| 4G | 63.0 | 2.8 | 2.8 | 1.4 |
| 4H | 63.0 | 4.2 | 2.8 | |
| 4I | 63.0 | 5.6 | 1.4 | |
| 4J | 63.0 | 2.8 | 1.4 | 2.8 |
| 4K | 63.0 | 1.4 | 1.4 | 4.2 |
| 4L | 63.0 | 2.8 | | 4.2 |
| 4M | 63.0 | 1.4 | | 5.6 |
| 4N | 63.0 | | 1.4 | 5.6 |
| 4O | 63.0 | | 2.8 | 4.2 |

### Example 5

Preparation of Dry Blend Mixtures of First Powder Coating Compositions Containing Opaque Particulates and Second Powder Compositions Containing Translucent Particulates Having External Colorant Particles Removably Adhered Thereto

Fourteen powder coating compositions were prepared from the powder coating compositions of Examples 2B and 3 in the amounts (grams) shown in Table 5. Each of the fourteen powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 2.

TABLE 5

| | Powder of | | | Powder of |
|---|---|---|---|---|
| Powder | Ex. 2B | Powder of Ex. 3A | Powder of Ex. 3B | Ex. 3C |
| 5A | 63.0 | 7.0 | | |
| 5B | 52.5 | 17.5 | | |
| 5C | 63.0 | | | 7.0 |
| 5D | 52.5 | | | 17.5 |
| 5E | 52.5 | 7.0 | | 10.5 |
| 5F | 52.5 | 3.5 | | 14.0 |
| 5G | 63.0 | | 7.0 | |
| 5H | 52.5 | | 17.5 | |
| 5I | 63.0 | 2.8 | 1.4 | 2.8 |
| 5J | 63.0 | 1.4 | 1.4 | 4.2 |
| 5K | 63.0 | | 2.8 | 4.2 |
| 5L | 63.0 | | 1.4 | 5.6 |
| 5M | 63.0 | 1.4 | 4.2 | 1.4 |
| 5N | 63.0 | 2.8 | 2.8 | 1.4 |

### Example 6

Preparation of Dry Blend Mixtures of First Powder Coating Compositions Containing Opaque Particulates and Second Powder Compositions Containing Translucent Particulates Having External Colorant Particles Removably Adhered Thereto

Fifteen powder coating compositions were prepared from the powder coating compositions of Examples 2C and 3 in the amounts (grams) shown in Table 6. Each of the fifteen powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 2

TABLE 6

| | Powder of | | | Powder of |
|---|---|---|---|---|
| Powder | Ex. 2C | Powder of Ex. 3A | Powder of Ex. 3B | Ex. 3C |
| 6A | 63.0 | | 7.0 | |
| 6B | 52.5 | | 17.5 | |
| 6C | 63.0 | 7.0 | | |
| 6D | 52.5 | 17.5 | | |
| 6E | 63.0 | | | 7.0 |
| 6F | 52.5 | | | 17.5 |
| 6G | 63.0 | 4.2 | 1.4 | 1.4 |
| 6H | 63.0 | 2.8 | 2.8 | 1.4 |
| 6I | 63.0 | 2.8 | 4.2 | |
| 6J | 63.0 | 2.8 | 1.4 | 2.8 |
| 6K | 63.0 | 1.4 | 2.8 | 2.8 |
| 6L | 63.0 | 1.4 | 4.2 | 1.4 |
| 6M | 63.0 | | 4.2 | 2.8 |
| 6N | 63.0 | | 5.6 | 1.4 |
| 6O | 63.0 | 5.6 | 1.4 | |

### Example 7

Preparation of Dry Blend Mixtures of First Powder Coating Compositions Containing Opaque Particulates and Second Powder Compositions Containing Translucent Particulates Having External Colorant Particles Removably Adhered Thereto

Fifteen powder coating compositions were prepared from the powder coating compositions of Examples 2D and 3 in the amounts (grams) shown in Table 7. Each of the fifteen powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 2.

TABLE 7

| | Powder of | | | Powder of |
|---|---|---|---|---|
| Powder | Ex. 2D | Powder of Ex. 3A | Powder of Ex. 3B | Ex. 3C |
| 7A | 63.0 | | 7.0 | |
| 7B | 52.5 | | 17.5 | |
| 7C | 63.0 | 7.0 | | |
| 7D | 52.5 | 17.5 | | |
| 7E | 63.0 | | | 7.0 |
| 7F | 52.5 | | | 17.5 |
| 7G | 63.0 | 4.2 | 1.4 | 1.4 |
| 7H | 63.0 | 2.8 | 2.8 | 1.4 |
| 7I | 63.0 | 2.8 | 4.2 | |
| 7J | 63.0 | 2.8 | 1.4 | 2.8 |
| 7K | 63.0 | 1.4 | 2.8 | 2.8 |
| 7L | 63.0 | 1.4 | 4.2 | 1.4 |
| 7M | 63.0 | | 4.2 | 2.8 |
| 7N | 63.0 | | 5.6 | 1.4 |
| 7O | 63.0 | 5.6 | 1.4 | |

### Example 8

Preparation of Dry Blend Mixtures of First Powder Coating Compositions Containing Opaque Particulates and Second Powder Compositions Containing Translucent Particulates Having External Colorant Particles Removably Adhered Thereto

Fifteen powder coating compositions were prepared from the powder coating compositions of Examples 2E and 3 in the amounts (grams) shown in Table 8. Each of the fifteen powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 3035 microns achieved in Example 2.

TABLE 8

| | Powder of | | | Powder of |
|---|---|---|---|---|
| Powder | Ex. 2E | Powder of Ex. 3A | Powder of Ex. 3B | Ex. 3C |
| 8A | 63.0 | | 7.0 | |
| 8B | 52.5 | | 17.5 | |
| 8C | 63.0 | 7.0 | | |
| 8D | 52.5 | 17.5 | | |
| 8E | 63.0 | | | 7.0 |
| 8F | 52.5 | | | 17.5 |
| 8G | 63.0 | 4.2 | 1.4 | 1.4 |
| 8H | 63.0 | 2.8 | 2.8 | 1.4 |
| 8I | 63.0 | 2.8 | 4.2 | |
| 8J | 63.0 | 2.8 | 1.4 | 2.8 |
| 8K | 63.0 | 1.4 | 2.8 | 2.8 |
| 8L | 63.0 | 1.4 | 4.2 | 1.4 |
| 8M | 63.0 | | 4.2 | 2.8 |
| 8N | 63.0 | | 5.6 | 1.4 |
| 8O | 63.0 | 5.6 | 1.4 | |

### Example 9

Preparation of Dry Blend Mixtures of First Powder Coating Compositions Containing Opaque Particulates and Second Powder Compositions Containing Translucent Particulates Having External Colorant Particles Removably Adhered Thereto

Six powder coating compositions were prepared from the powder coating compositions of Examples 2F and 3 in the amounts (grams) shown in Table 9. Each of the six powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 2.

TABLE 9

| | Powder of | | | Powder of |
|---|---|---|---|---|
| Powder | Ex. 2F | Powder of Ex. 3A | Powder of Ex. 3B | Ex. 3C |
| 9A | 63.0 | 7.0 | | |
| 9B | 52.5 | 17.5 | | |
| 9C | 63.0 | | | 7.0 |
| 9D | 52.5 | | | 17.5 |
| 9E | 52.5 | 7.0 | | 10.5 |
| 9F | 52.5 | 3.0 | | 14.0 |

### Example 10

Preparation of Dry Blend Mixtures of First Powder Coating Compositions Containing Opaque Particulates and Second Powder Compositions Containing Translucent Particulates Having External Colorant Particles Removably Adhered Thereto

Three powder coating compositions were prepared from the powder coating compositions of Examples 2C and 2D and 3 in the amounts (grams) shown in Table 10. Each of the three powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 2.

TABLE 10

| | Powder of | | | Powder of |
|---|---|---|---|---|
| Powder | Ex. 2C | Powder of Ex. 2D | Powder of Ex. 3B | Ex. 3C |
| 10A | 47.25 | 15.75 | 4.2 | 2.8 |
| 10B | 31.50 | 31.50 | 4.2 | 2.8 |
| 10C | 15.75 | 47.25 | 4.2 | 2.8 |

### Example 11

Preparation of Dry Blend Mixtures of First Powder Coating Compositions Containing Opaque Particulates and Second Powder Compositions Containing Translucent Particulates Having External Colorant Particles Removably Adhered Thereto

Three powder coating compositions were prepared from the powder coating compositions of Examples 2C and 2D and 3 in the amounts (grams) shown in Table 11. Each of the three powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 2

TABLE 11

| | Powder of | Powder of | Powder of | Powder of | Powder of |
|---|---|---|---|---|---|
| Powder | Ex. 2C | Ex. 2D | Ex. 3A | Ex. 3B | Ex. 3C |
| 11A | 47.25 | 15.75 | 1.4 | 4.2 | 1.4 |
| 11B | 31.50 | 31.50 | 1.4 | 4.2 | 1.4 |
| 11C | 15.75 | 47.25 | 1.4 | 4.2 | 1.4 |

### Example 12

Preparation of Dry Blend Mixtures of First Powder Coating Compositions Containing Opaque Particulates and Second Powder Compositions Containing Translucent Particulates Having External Colorant Particles Removably Adhered Thereto

Three powder coating compositions were prepared from the powder coating compositions of Examples 2B and 2F and 3 in the amounts (grams) shown in Table 12. Each of the three powder coating compositions was prepared by vigorously shaking the blended powder in a bag for 10 seconds, Further mixing of the blend was achieved using a MIKRO-ACM™ Model 1 AOM milling system; conditions were selected so that the average particle size was not reduced from the 30-35 microns achieved in Example 2.

TABLE 12

| | Powder | | Powder | |
|---|---|---|---|---|
| Powder | of Ex. 2B | Powder of Ex. 2F | of Ex. 3A | Powder of Ex. 3C |
| 12A | 47.25 | 15.75 | 2.8 | 4.2 |
| 12B | 31.50 | 31.50 | 2.8 | 4.2 |
| 12C | 15.75 | 47.25 | 2.8 | 4.2 |

### Example 13

Preparation of Dry Blend Mixtures of First Powder Coating Compositions Containing Opaque Particulates and Second Powder Compositions Containing Translucent Particulates Having External Colorant Particles Removably Adhered Thereto

Three powder coating compositions were prepared from the powder coating compositions of Examples 2A and 2E and 3 in the amounts (grams) shown in Table 13. Each of the three powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 2.

TABLE 13

| | Powder | Powder | Powder | Powder | Powder |
|---|---|---|---|---|---|
| Powder | of Ex. 2A | of Ex. 2E | of Ex. 3A | of Ex. 3B | of Ex. 3C |
| 13A | 47.25 | 15.75 | 2.8 | 2.8 | 1.4 |
| 13B | 31.50 | 31.50 | 2.8 | 2.8 | 1.4 |
| 13C | 15.75 | 47.25 | 2.8 | 2.8 | 1.4 |

### Example 14

Preparation of Dry Blend Mixtures of First Powder Coating Compositions Containing Opaque Particulates and Second Powder Compositions Containing Translucent Particulates Having External Colorant Particles Removably Adhered Thereto

Three powder coating compositions were prepared from the powder coating compositions of Examples 2C and 2E and 3 in the amounts (grams) shown in Table 14. Each of the three powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 2.

TABLE 14

| | Powder | Powder | Powder | Powder | Powder |
|---|---|---|---|---|---|
| Powder | of Ex. 2C | of Ex. 2E | of Ex. 3A | of Ex. 3B | of Ex. 3C |
| 14A | 47.25 | 15.75 | 1.4 | 2.8 | 2.8 |
| 14B | 31.50 | 31.50 | 1.4 | 2.8 | 2.8 |
| 14C | 15.75 | 47.25 | 1.4 | 2.8 | 2.8 |

### Example 15

Preparation of Dry Blend Mixtures of First Powder Coating. Compositions Containing Opaque Particulates and Second Powder Compositions Containing Translucent Particulates Having External Colorant Particles Removably Adhered Thereto

Three powder coating compositions were prepared from the powder coating compositions of Examples 2A and 2F and 3 in the amounts (grams) shown in Table 15. Each of the three powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 2.

TABLE 15

| | Powder | | Powder | |
|---|---|---|---|---|
| Powder | of Ex. 2A | Powder of Ex. 2F | of Ex. 3A | Powder of Ex. 3C |
| 15A | 47.25 | 15.75 | 2.8 | 4.2 |
| 15B | 31.50 | 31.50 | 2.8 | 4.2 |
| 15C | 15.75 | 47.25 | 2.8 | 4.2 |

### Example 16

### Visual Appearance Ratings and Color Measurements of Powder Coatings

Powder coating compositions described above were electrostatically applied to 4×6 inch aluminum panels and baked for 20 minutes at 170° C. Coating thicknesses ranged from 80 to 110 microns. Color measurements were made using a Minolta 3600d integrated sphere spectrophotometer. Results are set forth in Table 16. All measurements include specular component. Salt and pepper appearance of panels were rated visually using a scale from 1 to 10. Rating scale is as follows: 10—No salt and pepper was visible at 6 inches; 8—Very slight salt and pepper visible at 6 inches; 6—Slight salt and pepper visible at 6 inches; 4—Moderate salt and pepper visible at 6 inches; 2—Severe salt and pepper visible at 6 inches.

Hiding power of powder coatings was evaluated using Form M33 Black & White Spray Monitors available from The Leneta Company. The spray monitors were applied to the panels before powder application. If no portion of the spray monitor was visible after application and cure of powder at specified conditions, then the coating was recorded as being opaque. All of the coatings produced in the Example were opaque or nearly opaque.

TABLE 16

| | | | | | | Salt and |
|---|---|---|---|---|---|---|
| Powder | L* | a* | b* | C* | h° | Pepper |
| 2A | 49.59 | −17.29 | −34.51 | 38.60 | 243.38 | 10 |
| 2B | 49.52 | 32.46 | −12.61 | 34.82 | 338.77 | 10 |
| 2C | 81.34 | 1.14 | 65.19 | 65.20 | 89.00 | 10 |
| 2D | 42.80 | 39.72 | 16.18 | 42.89 | 22.17 | 10 |
| 2E | 46.24 | −17.46 | 16.59 | 24.09 | 136.47 | 10 |
| 2F | 40.33 | 2.73 | −24.75 | 24.90 | 276.29 | 10 |
| 4A | 36.78 | 5.04 | −19.55 | 20.19 | 284.46 | 6 |
| 4B | 33.06 | 9.82 | −10.22 | 14.17 | 313.87 | 10 |
| 4C | 41.47 | −8.09 | −32.96 | 33.94 | 256.20 | 10 |
| 4D | 36.62 | −3.03 | −29.90 | 30.05 | 264.21 | 7 |
| 4E | 41.48 | −15.85 | −1.39 | 15.91 | 185.01 | 8 |
| 4F | 39.26 | −11.83 | 7.69 | 14.11 | 146.98 | 4 |
| 4G | 37.56 | −3.40 | −19.14 | 19.44 | 259.92 | 8 |
| 4H | 37.99 | −0.60 | −27.26 | 27.26 | 268.75 | 7 |
| 4I | 39.09 | −0.53 | −26.16 | 26.16 | 268.84 | 8 |
| 4J | 39.69 | −9.66 | −14.16 | 17.14 | 235.70 | 9 |
| 4K | 39.04 | −10.08 | −10.32 | 14.43 | 225.69 | 9 |
| 4L | 39.86 | −14.69 | −9.90 | 17.71 | 213.99 | 8 |
| 4M | 40.45 | −15.50 | −6.23 | 16.70 | 201.89 | 6 |
| 4N | 39.85 | −10.90 | −5.21 | 12.09 | 205.56 | 10 |
| 4O | 38.87 | −7.38 | −8.57 | 11.31 | 229.26 | 10 |
| 5A | 36.77 | 2.67 | −25.38 | 25.52 | 276.01 | 6 |
| 5B | 33.25 | 2.44 | −23.33 | 23.46 | 275.98 | 9 |
| 5C | 47.40 | 29.21 | 14.01 | 32.39 | 25.62 | 7 |
| 5D | 46.79 | 30.56 | 22.85 | 38.16 | 36.79 | 8 |
| 5E | 33.90 | −3.81 | −3.46 | 5.15 | 222.25 | 6 |
| 5F | 35.52 | −2.53 | 2.38 | 3.47 | 136.81 | 6 |
| 5G | 43.57 | 38.17 | −1.75 | 38.21 | 357.38 | 6 |
| 5H | 40.14 | 38.55 | 5.51 | 38.94 | 8.14 | 8 |
| 5I | 37.65 | 3.79 | −10.60 | 11.26 | 289.66 | 4 |
| 5J | 39.88 | 7.68 | −5.05 | 9.19 | 326.70 | 5 |
| 5K | 45.50 | 33.39 | 6.74 | 34.07 | 11.42 | 6 |
| 5L | 46.62 | 31.25 | 9.17 | 32.57 | 16.35 | 6 |
| 5M | 38.12 | 12.51 | −10.67 | 16.44 | 319.54 | 3 |
| 5N | 37.36 | 7.31 | −14.42 | 16.17 | 296.88 | 4 |
| 6A | 57.06 | 27.96 | 33.00 | 43.25 | 49.73 | 3 |
| 6B | 48.51 | 40.99 | 24.14 | 47.57 | 30.49 | 3 |
| 6C | 51.80 | −34.83 | 14.49 | 37.72 | 157.42 | 2 |
| 6D | 40.83 | −27.91 | −0.70 | 27.92 | 181.43 | 2 |
| 6E | 77.71 | 11.88 | 67.56 | 68.60 | 80.03 | 9 |
| 6F | 74.43 | 20.70 | 69.53 | 72.55 | 73.42 | 9 |
| 6G | 52.08 | −24.28 | 18.87 | 30.75 | 142.15 | 2 |
| 6H | 50.42 | −11.19 | 22.70 | 25.31 | 116.24 | 1 |
| 6I | 50.42 | −10.79 | 18.00 | 20.98 | 120.93 | 2 |
| 6J | 54.88 | −20.63 | 25.04 | 32.44 | 129.49 | 2 |
| 6K | 55.46 | −7.68 | 27.73 | 28.78 | 105.49 | 2 |
| 6L | 53.81 | −3.72 | 24.49 | 24.77 | 98.64 | |
| 6M | 62.23 | 27.07 | 41.11 | 49.22 | 56.64 | 3 |
| 6N | 60.37 | 29.29 | 37.85 | 47.86 | 52.27 | 3 |
| 6O | 50.11 | −27.02 | 13.94 | 30.40 | 152.72 | 2 |
| 7A | 41.82 | 39.38 | 16.20 | 42.58 | 22.36 | 10 |
| 7B | 40.39 | 38.70 | 15.80 | 41.81 | 22.21 | 10 |
| 7C | 30.72 | 7.10 | −6.26 | 9.46 | 318.59 | 9 |
| 7D | 28.93 | 4.58 | −8.74 | 9.87 | 297.67 | 10 |
| 7E | 41.99 | 33.57 | 17.17 | 37.71 | 27.08 | 10 |
| 7F | 43.03 | 36.03 | 21.65 | 42.04 | 30.99 | 10 |
| 7G | 31.99 | 8.19 | −2.10 | 8.46 | 345.59 | 9 |
| 7H | 32.80 | 10.76 | −0.54 | 10.78 | 357.13 | 9 |
| 7I | 32.69 | 11.76 | −1.03 | 11.80 | 355.01 | 8 |
| 7J | 33.32 | 10.62 | 0.65 | 10.64 | 3.50 | 9 |
| 7K | 35.24 | 16.23 | 4.39 | 16.81 | 15.14 | 8 |
| 7L | 35.11 | 17.23 | 3.94 | 17.67 | 12.90 | 8 |
| 7M | 42.45 | 38.98 | 17.61 | 42.78 | 24.31 | 9 |
| 7N | 42.26 | 39.41 | 17.03 | 42.93 | 23.37 | 10 |
| 7O | 31.17 | 7.79 | −5.09 | 9.30 | 326.84 | 10 |
| 8A | 37.36 | 0.81 | 5.30 | 5.36 | 81.35 | 8 |
| 8B | 34.00 | 8.89 | 3.07 | 9.41 | 19.02 | 10 |
| 8C | 35.92 | −11.31 | −2.11 | 11.50 | 190.56 | 6 |
| 8D | 32.39 | −5.81 | −7.21 | 9.26 | 231.12 | 7 |
| 8E | 44.94 | −13.32 | 18.93 | 23.15 | 125.13 | 10 |
| 8F | 44.28 | −9.62 | 21.94 | 23.96 | 113.69 | 10 |
| 8G | 36.79 | −10.19 | 1.50 | 10.30 | 171.63 | 6 |
| 8H | 37.05 | −7.95 | 2.78 | 8.42 | 160.74 | 7 |
| 8I | 35.90 | −5.32 | 0.49 | 5.35 | 174.77 | 6 |
| 8J | 38.31 | −10.97 | 5.71 | 12.37 | 152.49 | 4 |
| 8K | 38.29 | −7.87 | 6.34 | 10.10 | 141.16 | 6 |
| 8L | 37.11 | −5.06 | 4.10 | 6.51 | 141.02 | 7 |
| 8M | 39.26 | −3.60 | 8.81 | 9.51 | 112.25 | 7 |
| 8N | 37.81 | −0.55 | 6.36 | 6.39 | 94.96 | 7 |
| 8O | 35.89 | −9.42 | −1.36 | 9.52 | 188.20 | 5 |
| 9A | 35.87 | 2.10 | −26.66 | 26.74 | 274.49 | |
| 9B | 33.00 | 2.79 | −24.12 | 24.28 | 276.59 | |
| 9C | 38.32 | −3.22 | −2.90 | 4.34 | 222.04 | 9 |
| 9D | 37.40 | −2.28 | 5.90 | 6.33 | 111.14 | 9 |
| 9E | 33.29 | −4.46 | −5.07 | 6.75 | 228.66 | 7 |
| 9F | 34.44 | −5.02 | −0.51 | 5.04 | 185.81 | 8 |
| 10A | 56.78 | 30.48 | 34.30 | 45.89 | 48.37 | 2 |
| 10B | 52.54 | 34.60 | 29.08 | 45.20 | 40.04 | 2 |
| 10C | 47.72 | 36.81 | 23.35 | 43.59 | 32.39 | 2 |
| 11A | 37.38 | 13.55 | −5.78 | 14.73 | 336.90 | 4 |
| 11B | 36.32 | 14.26 | −2.29 | 14.44 | 350.86 | 6 |
| 11C | 35.70 | 15.48 | 0.87 | 15.51 | 3.22 | 7 |
| 12A | 34.05 | −3.63 | 4.52 | 5.80 | 231.23 | 5 |
| 12B | 33.89 | −4.05 | −4.77 | 6.26 | 229.71 | 5 |
| 12C | 33.54 | −4.11 | −5.25 | 6.67 | 231.93 | 5 |
| 13A | 37.13 | −6.91 | −11.04 | 13.03 | 237.98 | |
| 13B | 36.76 | −7.58 | −6.15 | 9.76 | 219.07 | 7 |
| 13C | 36.69 | −7.72 | −1.71 | 7.91 | 192.47 | 6 |
| 14A | 52.12 | −9.22 | 24.12 | 25.83 | 110.92 | 1 |
| 14B | 47.49 | −9.63 | 18.36 | 20.73 | 117.67 | 1 |
| 14C | 42.76 | −8.98 | 12.35 | 15.27 | 126.03 | 1 |
| 15A | 38.82 | −11.18 | −10.64 | 15.44 | 223.58 | 7 |
| 15B | 37.89 | −8.36 | −10.99 | 13.81 | 232.73 | 7 |
| 15C | 37.22 | −5.90 | −11.17 | 12.64 | 242.16 | 8 |

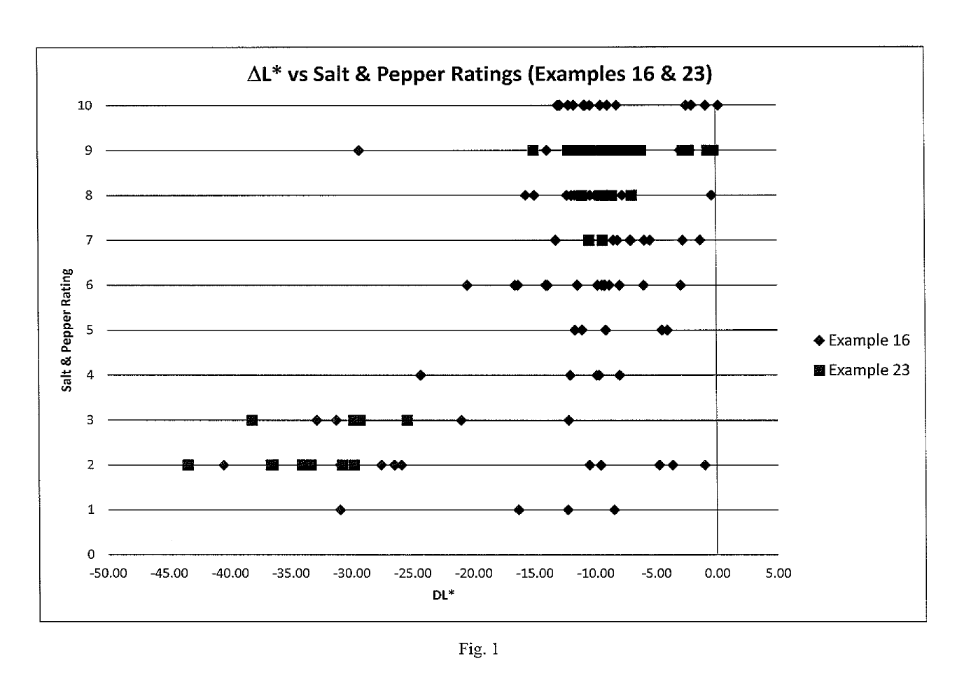

FIG. 1 is a plot of salt & pepper rating v. ΔL* value (between the L* of the cured coating and the L* value of a cured coating deposited from the opaque coating composition from which the example coating was derived) and shows the relationship between the two in Example 16.

### Example 17

### Preparation of Powder Coating Composition Intermediate

This example describes the preparation of a core formula of dry materials used to make the powder coating compositions of the subsequent Examples. The core formula was prepared from the ingredients of Table 1 in the ratios indicated. Components 1 to 4 were premixed in a Henschel Blender.

TABLE 17

| Component | Ingredients | Parts by Weight |
|---|---|---|
| 1 | Resiflow PL-200A²⁴ | 58.5 |
| 2 | Benzoin⁵ | 36.5 |
| 3 | Triglycidyl Isocyanurate⁸ | 487.7 |
| 4 | Uralac P6701⁶ | 6417.3 |

²⁴Commercially available from Estron Chemical

### Example 18

### Preparation of Powder Coating Composition Containing Opaque Particulates

Powder coating compositions were prepared from the powder coating composition intermediate of Example 17 and pigments in the amounts (grams) shown in Table 18. The powder coating compositions was prepared by vigorously shaking the intermediate and pigments in a bag for 20 seconds. The powder composition was then extruded using an APV MP19PC co-rotating twin screw extruder. The extrudate was cooled and then ground in a MIKRO-ACM™ Model 1 AOM milling system to a particle size of about 30-35 microns.

TABLE 18

| | 18A | 18B | 18C |
|---|---|---|---|
| Powder of Example | 2037.0 | 2242.5 | 2026.8 |
| 17 | | | |
| TiO₂⁹ | 42.0 | 46.0 | 109.5 |
| PR122¹¹ | 21.0 | | |
| PB15:3¹⁰ | | 11.5 | |
| PY184¹² | | | 141.9 |

### Example 19

### Preparation of Powder Coating Compositions Containing Opaque Particulates Having External Colorant Particles Removably Adhered Thereto

Cyan, magenta, and yellow powder coating compositions were prepared from powder coating composition intermediates of Example 18 and various pigments in the amounts (grams) shown in Table 19. Each of the nine powder coating compositions was prepared by vigorously shaking the intermediate and pigments in a bag for 20 seconds.

TABLE 19

| Powder | 18A | 18B | 18C | PB15:3⁷ | PV19²² | PY110²³ |
|---|---|---|---|---|---|---|
| 19A | | 58.5 | | 6.5 | | |
| 19B | | 58.5 | | | 6.5 | |
| 19C | | 67.5 | | | | 7.5 |
| 19D | 58.5 | | | 6.5 | | |
| 19E | 58.5 | | | | 6.5 | |
| 19F | 81.0 | | | | | 9.0 |
| 19G | | | 58.5 | 6.5 | | |
| 19H | | | 67.5 | | 7.5 | |
| 19I | | | 58.5 | | | 6.5 |

### Example 20

Preparation of Dry Blend Mixtures of First Powder Coating Compositions Containing Opaque Particulates and Second Powder Compositions Containing Opaque Particulates Having External Colorant Particles Removably Adhered Thereto

Fourteen powder coating compositions were prepared from the powder coating compositions of Examples 18B and 19 in the amounts (grams) shown in Table 20. Each of the fourteen powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 18.

TABLE 20

| | Powder | Powder | Powder | |
|---|---|---|---|---|
| Powder | of Ex. 18B | of Ex. 19A | of Ex. 19B | Powder of Ex. 19C |
| 20A | 63.0 | | 7.0 | |
| 20B | 52.5 | | 17.5 | |
| 20C | 63.0 | 7.0 | | |
| 20D | 52.5 | 17.5 | | |
| 20E | 63.0 | | | 7.0 |
| 20F | 52.5 | | | 17.5 |
| 20G | 63.0 | 2.8 | 2.8 | 1.4 |
| 20H | 63.0 | 4.2 | 2.8 | |
| 20I | 63.0 | 5.6 | 1.4 | |
| 20J | 63.0 | 2.8 | 1.4 | 2.8 |
| 20K | 63.0 | 1.4 | 1.4 | 4.2 |
| 20L | 63.0 | 2.8 | | 4.2 |
| 20M | 63.0 | 1.4 | | 5.6 |
| 20N | 63.0 | | 1.4 | 5.6 |

### Example 21

Preparation of Dry Blend Mixtures of First Powder Coating Compositions Containing Opaque Particulates and Second Powder Compositions Containing Opaque Particulates Having External Colorant Particles Removably Adhered Thereto

Fourteen powder coating compositions were prepared from the powder coating compositions of Examples 18A and 19 in the amounts (grams) shown in Table 21. Each of the fourteen powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 18.

TABLE 21

| | Powder | Powder | Powder | |
|---|---|---|---|---|
| Powder | of Ex. 18A | of Ex. 19D | of Ex. 19E | Powder of Ex. 19F |
| 21A | 63.0 | 7.0 | | |
| 21B | 52.5 | 17.5 | | |
| 21C | 63.0 | | | 7.0 |
| 21D | 52.5 | | | 17.5 |
| 21E | 52.5 | 7.0 | | 10.5 |
| 21F | 52.5 | 17.5 | | 14.0 |
| 21G | 63.0 | | 7.0 | |
| 21H | 52.5 | | 17.5 | |
| 21I | 63.0 | 2.8 | 1.4 | 2.8 |
| 21J | 63.0 | 1.4 | 1.4 | 4.2 |
| 21K | 63.0 | | 2.8 | 4.2 |
| 21L | 63.0 | | 1.4 | 5.6 |
| 21M | 63.0 | 1.4 | 4.2 | 1.4 |
| 21N | 63.0 | 2.8 | 2.8 | 1.4 |

### Example 22

Preparation of Dry Blend Mixtures of First Powder Coating Compositions Containing Opaque Particulates and Second Powder Compositions Containing Opaque Particulates Having External Colorant Particles Removably Adhered Thereto

Fourteen powder coating compositions were prepared from the powder coating compositions of Examples 18C and 19 in the amounts (grams) shown in Table 22. Each of the fourteen powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 18.

TABLE 22

| | Powder | Powder | Powder | |
|---|---|---|---|---|
| Powder | of Ex. 18C | of Ex. 19G | of Ex. 19H | Powder of Ex. 19I |
| 22A | 63.0 | | 7.0 | |
| 22B | 52.5 | | 17.5 | |
| 22C | 63.0 | 7.0 | | |
| 22D | 52.5 | 17.5 | | |
| 22E | 63.0 | | | 7.0 |
| 22F | 52.5 | | | 17.5 |
| 22G | 63.0 | 4.2 | 1.4 | 1.4 |
| 22H | 63.0 | 2.8 | 2.8 | 1.4 |
| 22I | 63.0 | 2.8 | 4.2 | |
| 22J | 63.0 | 2.8 | 1.4 | 2.8 |
| 22K | 63.0 | 1.4 | 2.8 | 2.8 |
| 22L | 63.0 | 1.4 | 4.2 | 1.4 |
| 22M | 63.0 | | 4.2 | 2.8 |
| 22N | 63.0 | | 5.6 | 1.4 |
| 22O | 63.0 | 5.6 | 1.4 | |

### Example 23

### Visual Appearance Ratings and Color Measurements of Powder Coatings

Each of the powder coatings from Examples 18 and 20-22 was electrostatically applied to 4×6 inch aluminum panels and baked for 20 minutes at 170° C. Coating thicknesses ranged from 80 to 110 microns. Color measurements were made using a Minolta 3600d integrated sphere spectrophotometer. Results are set forth in Table 23. All measurements include specular component. Salt and pepper appearance of panels were rated visually using a scale from 1 to 10. Rating scale is as follows: 10—No salt and pepper was visible at 6 inches; 8—Very slight salt and pepper visible at 6 inches; 6—Slight salt and pepper visible at 6 inches; 4—Moderate salt and pepper visible at 6 inches; 2—Severe salt and pepper visible at 6 inches.

Hiding power of powder coatings was evaluated using Form M33 Black & White Spray Monitors available from The Leneta Company. The spray monitors were applied to the panels before powder application. If no portion of the spray monitor was visible after application and cure of powder at specified conditions, then the coating was recorded as being opaque. All of the coatings in Table 23 were opaque or nearly opaque.

TABLE 23

| | | | | | | Salt and |
|---|---|---|---|---|---|---|
| Powder | L* | a* | b* | C* | h° | Pepper |
| 18A | 43.36 | 42.27 | −10.66 | 43.59 | 345.84 | 10 |
| 18B | 48.77 | −15.76 | −35.97 | 39.27 | 246.34 | 10 |
| 18C | 89.62 | −10.39 | 74.78 | 75.49 | 97.91 | 10 |
| 20A | 37.32 | 3.91 | −21.69 | 22.03 | 280.21 | 9 |
| 20B | 33.81 | 9.61 | −13.48 | 16.56 | 305.48 | 9 |
| 20C | 42.22 | −8.99 | −33.42 | 34.60 | 254.95 | 9 |
| 20D | 38.34 | −4.27 | −31.59 | 31.88 | 262.30 | 7 |
| 20E | 42.22 | −17.85 | −7.45 | 19.34 | 202.66 | 9 |
| 20F | 39.51 | −13.67 | 4.60 | 14.42 | 161.38 | 9 |
| 20G | 41.63 | −7.77 | −24.35 | 25.56 | 252.31 | 9 |
| 20H | 39.12 | 1.32 | −24.82 | 24.85 | 273.04 | 9 |
| 20J | 37.52 | 2.08 | −24.31 | 24.40 | 274.89 | 9 |
| 20K | 38.48 | −5.86 | −16.28 | 17.30 | 250.19 | 9 |
| 20L | 39.94 | −12.06 | −12.99 | 17.73 | 227.14 | 9 |
| 20M | 39.44 | −8.20 | −12.70 | 15.11 | 237.15 | 7 |
| 20N | 40.42 | −12.33 | −9.49 | 15.56 | 217.58 | 9 |
| 21A | 33.06 | 12.77 | −24.97 | 28.05 | 297.08 | 9 |
| 21B | 31.26 | 9.30 | −23.89 | 25.63 | 291.28 | 9 |
| 21C | 43.18 | 37.89 | 4.79 | 38.19 | 7.21 | 9 |
| 21D | 43.17 | 36.64 | 14.52 | 39.41 | 21.63 | 9 |
| 21E | 32.28 | 4.45 | −8.57 | 9.65 | 297.46 | 9 |
| 21F | 33.97 | 7.09 | −3.41 | 7.86 | 334.33 | 8 |
| 21G | 41.17 | 38.64 | −4.06 | 38.86 | 354.00 | 9 |
| 21H | 40.66 | 40.74 | 3.40 | 40.88 | 4.77 | 9 |
| 21I | 34.81 | 14.35 | −14.43 | 20.35 | 314.85 | 8 |
| 21J | 36.45 | 17.98 | −9.32 | 20.25 | 332.60 | 8 |
| 21K | 42.70 | 39.32 | 2.72 | 39.41 | 3.96 | 9 |
| 21L | 42.88 | 38.83 | 3.30 | 38.97 | 4.86 | 9 |
| 21M | 35.83 | 19.95 | −12.38 | 23.48 | 328.18 | 9 |
| 21N | 34.42 | 15.41 | −16.44 | 22.54 | 313.14 | 9 |
| 22A | 60.34 | 27.32 | 35.61 | 44.88 | 52.50 | 3 |
| 22B | 51.47 | 43.44 | 27.24 | 51.27 | 32.09 | 3 |
| 22C | 56.30 | −44.33 | 19.75 | 48.53 | 155.99 | 2 |
| 22D | 46.18 | −39.28 | 4.69 | 39.56 | 173.19 | 2 |
| 22E | 83.51 | 5.71 | 73.64 | 73.87 | 85.56 | 9 |
| 22F | 78.63 | 18.08 | 74.33 | 76.49 | 76.33 | 8 |
| 22G | 55.58 | −29.57 | 22.37 | 37.08 | 142.89 | 2 |
| 22H | 55.80 | −18.88 | 24.30 | 30.77 | 127.85 | 2 |
| 22I | 53.03 | −13.03 | 20.10 | 23.96 | 122.95 | 2 |
| 22J | 58.88 | −23.06 | 30.09 | 37.91 | 127.47 | 2 |
| 22K | 59.83 | −9.33 | 32.79 | 34.09 | 105.88 | 2 |
| 22L | 56.18 | −5.14 | 26.75 | 27.24 | 100.88 | 2 |
| 22M | 64.22 | 19.65 | 41.90 | 46.28 | 64.87 | 3 |
| 22N | 59.82 | 15.85 | 34.42 | 37.90 | 65.28 | 3 |
| 22O | 53.15 | −30.51 | 17.33 | 35.09 | 150.41 | 2 |

These color measurements show that a large number of hues can be achieved by appropriately selecting the first opaque powder coating compositions and second opaque coating compositions containing unbound external colorant and mixing them in the proper proportion. Use of the unbound external colorant significantly reduced the salt and pepper visible in most of the powders. FIG. 1 is a plot of salt & pepper rating v. ΔL* value (between the L* of the cured coating and the L* value of a cured coating deposited from the opaque coating composition from which the example coating was derived) and shows the relationship between the two in Example 23.

### Example 24

### Preparation of Intermediate Coating Compositions Containing Internal Pigments

This example describes the preparation of a core formula of dry materials used to make the powder coating compositions of the subsequent Examples. The core formula was prepared from the ingredients of Table 24 in the ratios indicated. Components 1 to 8 were premixed in a Henschel Blender. The powder composition was then extruded using an APV MP19PC co-rotating twin screw extruder. The extrudate was cooled and then ground in a MIKRO-ACM™ Model 1 AOM milling system to a particle size of about 30-35 microns.

TABLE 24

| Component | Ingredients | Parts by Weight |
|---|---|---|
| 1 | Uralac P 800⁶ | 4857.6 |
| 2 | Primid XL552²⁵ | 213.1 |
| 3 | Songnox 1076 PW¹ | 82.5 |
| 4 | Benzoin⁵ | 38.5 |
| 5 | Resiflow PL-200A²⁴ | 61.0 |
| 6 | Tiona 595⁹ | 310.1 |
| 7 | L1100 Sicopal Yellow¹² | 803.6 |
| 8 | Barimite XF¹⁴ | 633.7 |

²⁵Commercially available from EMS

### Example 25

Preparation of Powder Coating Compositions Containing Opaque Particulates Having External Colorant Particles Removably Adhered Thereto

A powder coating composition was prepared from powder coating composition intermediate of Example 24 and a red pigment in the amounts (grams) shown in Table 25. The powder coating composition was prepared by vigorously shaking the intermediate and pigments in a bag for 20 seconds.

TABLE 25

| Component | Ingredients | Parts by Weight |
|---|---|---|
| 1 | Powder of Example 24 | 2500.0 |
| 2 | PR170¹⁵ | 277.8 |

### Example 26

Preparation of Dry Blend Mixtures of First Powder Coating Compositions Containing Opaque Particulates and Second Powder Compositions Containing Opaque Particulates Having External Colorant Particles Removably Adhered Thereto

Three powder coating compositions were prepared from the powder coating compositions of Examples 24 and 25 in the amounts (grams) shown in Table 26. Each of the three powder coating compositions was prepared by vigorously shaking the blended powder in a bag for 10 seconds. Further mixing of the blend was achieved using a MIKRO-ACM™ Model 1 AOM milling system; conditions were selected so that the average particle size was not reduced from the 30-35 microns achieved in Example 24.

TABLE 26

| | | Powder | |
|---|---|---|---|
| Powder | Weight % PR170 | of Example 24 | Powder of Example 25 |
| 26A | 0.2% | 882.1 | 17.9 |
| 26B | 1.0% | 810.0 | 90.0 |
| 26C | 5.0% | 450.0 | 450.0 |

### Example 27

### Preparation of Powder Coating Composition Containing Internal Colorant Particles

A powder coating composition was prepared containing internal colorant particles. The formula was prepared from the ingredients of Table 27 in the ratios indicated. Components 1 to 9 were mixed by vigorously shaking the blended powder in a bag for 10 seconds. The powder composition was then extruded using an APV MP19PC co-rotating twin screw extruder. The extrudate was cooled and then ground in a MIKRO-ACM™ Model 1 AOM milling system to a particle size of about 30-35 microns.

TABLE 27

| Component | Ingredients | Parts by Weight |
|---|---|---|
| 1 | Uralac P 800⁶ | 272.8 |
| 2 | Primid XL552²⁵ | 12.0 |
| 3 | Songnox 1076 PW¹ | 4.6 |
| 4 | Benzoin⁵ | 2.2 |
| 5 | Resiflow PL-200A²⁴ | 3.4 |
| 6 | Tiona 595²⁶ | 12.8 |
| 7 | L1100 Sicopal Yellow¹² | 33.1 |
| 8 | Barimite XF¹⁴ | 34.1 |
| 9 | PR170¹⁵ | 20.0 |

### Example 28

### Gloss Measurements and Solvent Resistance of Applied Coatings

Each of the powder coatings from Examples 26 and 27 was electrostatically applied to 4×6 inch aluminum panels and baked for 20 minutes at 170° C. Coating thicknesses ranged from 80 to 110 microns. Gloss measurements (60°) taken with a BYK-Gardner micro-TRI-gloss meter available from BYK-Gardner GmbH. Methylethyl ketone solvent resistance was evaluated by soaking cotton swabs in methylethyl ketone solvent and gently rubbing the swabs across the surface of the cured panel. The swab is rewetted after 50 rubs and the process repeated for a total of 100 rubs. The discoloration of the cotton swab was then evaluated and rated on a scale of 1 to 5. Rating scale is as follows: 5—No discoloration of cotton swab after 100 rubs; 4—Very slight discoloration of cotton swab after 100 rubs; 3—Slight discoloration of cotton swab after 100 rubs; 2—Moderate discoloration of cotton swab after 100 rubs; 1—Severe discoloration of cotton swab after 100 rubs. Results are set forth in Table 28.

TABLE 28

| | Red Colorant | | | Solvent |
|---|---|---|---|---|
| Coating | Type | % Red Colorant | Gloss (60°) | Resistance |
| 26A | External | 0.2% | 90.6 | 3 |
| 26B | External | 1.0% | 89.7 | 1 |
| 26C | External | 5.0% | 79.3 | 1 |
| 27 | Internal | 5.0% | 89.5 | 2 |

These results demonstrate that increasing the level of unbound external colorant in the intermixed powder reduces the solvent resistance and gloss of the resulting coating.

### Example 29

### QUV Accelerated Weathering of Applied Coatings

Each of the powder coatings from Examples 26 and 27 was electrostatically applied to 4×6 inch aluminum panels and baked for 20 minutes at 170° C. Coating thicknesses ranged from 80 to 110 microns. QUV accelerated weathering for the coated panels were evaluated using an Atlas QUV configured to the following conditions: UVA340 bulbs, 8 hours UV (70° C.) at 0.89 irradiance, and 4 hours condensation (40° C.). Testing carried out using model number QUV/SE supplied by Q-Panel Lab Products. Color measurements for the panels were taken before exposure and after 2000 hours of exposure. Difference in color for each panel was also calculated. Results are set forth in Table 29. Color measurements were made using a Minolta 3600d integrated sphere spectrophotometer. All measurements include specular component.

TABLE 29

| | Powder | Powder | Powder | |
|---|---|---|---|---|
| | of Ex. 26A | of Ex. 26B | of Ex. 26C | Powder of Ex. 27 |
| Initial L* | 76.70 | 63.71 | 47.09 | 47.22 |
| Initial a* | 8.18 | 26.92 | 46.83 | 49.07 |
| Initial b* | 59.90 | 45.53 | 26.74 | 26.34 |
| Initial C* | 60.45 | 51.18 | 53.92 | 55.69 |
| Initial h^{o} | 82.23 | 58.26 | 29.72 | 28.23 |
| Final L* | 79.28 | 68.13 | 50.41 | 48.46 |
| Final a* | 1.99 | 16.64 | 38.96 | 44.54 |
| Final b* | 62.32 | 47.04 | 26.64 | 24.79 |
| Final C* | 62.35 | 49.90 | 47.20 | 50.97 |
| Final h^{o} | 88.17 | 70.51 | 34.37 | 29.11 |
| ΔL* | 2.58 | 4.42 | 3.32 | 1.24 |
| Δa* | −6.18 | −10.28 | −7.87 | −4.53 |
| Δb* | 2.42 | 3.51 | −0.09 | −1.55 |
| ΔC* | 1.90 | −1.29 | −6.72 | −4.72 |
| Δh^{o} | 5.94 | 12.25 | 4.64 | 0.88 |
| ΔE | 7.12 | 11.73 | 8.54 | 4.85 |

These results demonstrate that increasing the level of unbound external colorant in the intermixed powder could lead to larger shifts in color after accelerated weathering.

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

We claim:

1. A powder coating composition comprising:
(a) opaque particulates comprising:
(i) a film-forming resin; and
(ii) an internal colorant;
(b) translucent particulates comprising:
(i) a film-forming resin; and
(ii) an internal colorant; and
(c) external colorant particles removably adhered to the opaque particulates and the translucent particulates,
wherein the powder coating composition, when deposited upon a substrate and cured, produces a coating having an L* value within 20 units of the L* value of a coating deposited from the opaque particulates alone.

2. The powder coating composition of claim 1, wherein the opaque particulates have a hue selected from yellow, magenta, and cyan.

3. The powder coating composition of claim 1, wherein the translucent particulates have a hue selected from yellow, magenta, and cyan.

4. The powder coating composition of claim 1, wherein the translucent particulates are present in an amount of no more than 20 percent by weight based on the total weight of the powder coating composition.

5. The powder coating composition of claim 1, wherein the external colorant particles are present in an amount of 0.01 to 10 percent by weight, based on the total weight of the powder coating composition.

6. A powder coating composition comprising:
(a) opaque particulates comprising:
(i) a film-forming resin; and
(ii) an internal colorant; and
(b) external colorant particles removably adhered to the opaque particulates,
wherein the powder coating composition, when deposited upon a substrate and cured, produces a coating having an L* value within 20 units of the L* value of a coating deposited from the opaque particulates alone.

7. The powder coating composition of claim 6, wherein substantially all of the opaque particulates are of the same hue.

8. The powder coating composition of claim 6, wherein the opaque particulates have a hue selected from yellow, magenta, and cyan.

9. The powder coating composition of claim 1, wherein the translucent particulates are present in an amount of no more than 20 percent by weight based on the total weight of the powder coating composition.

10. The powder coating composition of claim 1, wherein the external colorant particles are present in an amount of 0.01 to 10 percent by weight, based on the total weight of the powder coating composition.

11. A method of making a powder coating composition comprising mixing at least one first powder coating composition and at least one second powder coating composition, wherein:
(a) the at least one first powder coating composition, when deposited upon a substrate and cured, provides a cured coating having a first hue and a first L* value, the first powder coating composition comprising opaque particulates comprising:
(i) a film-forming resin; and
(ii) an internal colorant; and
(b) the at least one second powder coating composition comprises:
(i) particulates comprising:
(A) a film-forming resin; and
(B) an internal colorant, and
(ii) external colorant particles removably adhered to the particulates; and
(c) the mixture, when deposited upon a substrate and cured, produces a coating having a second hue and an L* value within 20 units of the first L* value.

12. The method of claim 11, wherein the particulates of the at least one first powder coating composition have a hue selected from yellow, magenta, and cyan.

13. The method of claim 11, wherein the second powder coating composition comprises translucent particulates.

14. The method of claim 13, wherein the mixture comprises no more than 20 percent by weight based on the total weight of the mixture, of translucent particulates.

15. The method of claim 11, wherein the external colorant particles are present in the mixture in an amount of 0.01 to 10 percent by weight, based on the total weight of the mixture.

16. A powder coating system comprising:
(a) at least one first powder coating composition comprising opaque particulates having a first hue;
(b) at least one second powder coating composition comprising opaque particulates having a second hue different from the first hue;
(c) at least one third powder coating composition comprising opaque particulates having a third hue different from the first and second hue; and
(d) at least one fourth powder coating composition comprising translucent or opaque particulates having a fourth hue and having external colorant particles removably adhered thereto.

17. The powder coating system of the claim 16, wherein the first hue is a cyan hue, the second hue is a magenta hue, and the third hue is a yellow hue.

18. The powder coating system of claim 16, wherein the fourth powder coating composition comprises translucent particulates.

19. The powder coating system of claim 16, further comprising:
(e) at least one fifth powder coating composition comprising translucent or opaque particulates having a fifth hue different from the fourth hue and external colorant particles removably adhered thereto; and
(f) at least one sixth powder coating composition comprising translucent or opaque particulates having a sixth hue different from the fourth hue and the fifth hue and external colorant particles removably adhered thereto.

20. The powder coating system of claim 16, wherein the at least one first powder coating composition comprises at least three powder coating compositions having the first hue.

21. The powder coating system of claim 20, wherein the at least three powder coating compositions having the first hue comprises:
(a) a powder coating composition comprising particulates that, when deposited upon a substrate and cured, produces a coating having an L* value of at least 70;
(b) a powder coating composition comprising particulates that, when deposited upon a substrate and cured, produces a coating having an L* value of greater than 30 to less than 70; and
(c) a powder coating composition comprising particulates that, when deposited upon a substrate and cured, produces a coating having an L* value of no more than 30.

22. The powder coating system of claim 16, wherein the at least one second powder coating composition comprises at least three powder coating compositions having the second hue.

23. The powder coating system of claim 22, wherein the at least three powder coating compositions having the second hue comprises:
(a) a powder coating composition comprising particulates that, when deposited upon a substrate and cured, produces a coating having an L* value of at least 70;
(b) a powder coating composition comprising particulates that, when deposited upon a substrate and cured, produces a coating having an L* value of greater than 30 to less than 70; and
(c) a powder coating composition comprising particulates that, when deposited upon a substrate and cured, produces a coating having an L* value of no more than 30.

24. The powder coating system of claim 16, wherein the at least one third powder coating composition comprises at least three powder coating compositions having the third hue.

25. The powder coating system of claim 24, wherein the at least three powder coating compositions having the third hue comprises:
(a) a powder coating composition comprising particulates that, when deposited upon a substrate and cured, produces a coating having an L* value of at least 70;
(b) a powder coating composition comprising particulates that, when deposited upon a substrate and cured, produces a coating having an L* value of greater than 30 to less than 70; and
(c) a powder coating composition comprising particulates that, when deposited upon a substrate and cured, produces a coating having an L* value of no more than 30.

26. A method for making an opaque coating having a preselected hue comprising:
(a) mixing one or more first powder coating compositions and one or more second powder coating compositions to form a mixture; and
(b) depositing the mixture onto a substrate to form an opaque coating having a homogenous hue wherein a ΔE between the hue of the coating and the preselected hue is no more than 1, wherein
(1) the one or more first powder coating compositions, when deposited upon a substrate and cured, provides a cured coating having a first L* value and comprises opaque particulates comprising:
(i) a film-forming resin; and
(ii) an internal colorant;
(2) the one or more second powder coating compositions comprise:
(i) translucent or opaque particulates comprising:
(A) a film-forming resin; and
(B) an internal colorant; and
(ii) external colorant particles removably adhered to the particulates, and
(3) the mixture, when deposited upon a substrate and cured, produces a coating having an L* value within 20 units of the first L* value.
